(19) United States
(12) Patent Application Publication
(10) Pub. No.: US 2025/0105950 A1
(43) Pub. Date: Mar. 27, 2025

(54) TECHNIQUES FOR ADAPTATION OF HYBRID AUTOMATIC REPEAT REQUEST RETRANSMISSION HANDLING

(71) Applicant: QUALCOMM Incorporated, San Diego, CA (US)

(72) Inventors: Sitaramanjaneyulu KANAMARLAPUDI, San Diego, CA (US); Hobin KIM, San Diego, CA (US); Leena ZACHARIAS, San Jose, CA (US); Arnaud MEYLAN, San Diego, CA (US); Akshay KUMAR, San Diego, CA (US)

(21) Appl. No.: 18/804,700

(22) Filed: Aug. 14, 2024

Related U.S. Application Data
(60) Provisional application No. 63/585,031, filed on Sep. 25, 2023.

(51) Int. Cl. H04L 1/1867; H04L 1/1812

(52) U.S. Cl. CPC H04L 1/189; H04L 1/1819

(57) ABSTRACT

Various aspects of the present disclosure generally relate to wireless communication. In some aspects, a user equipment (UE) may obtain hybrid automatic repeat request (HARQ) information indicating whether the network node is configured to perform a retransmission of decoding information prior to an end of HARQ processes associated with the network node. The UE may receive, for a HARQ process associated with a downlink communication from the network node, a retransmission of a transport block (TB) that is associated with a reserved MCS when full decoding information for the TB is unavailable. The UE may perform, based on a reception of a retransmission, an action to proceed with the HARQ process, to restart the HARQ process, or to terminate the HARQ process, wherein the action is based on whether the network node is configured to perform the retransmission of the indication of the MCS. Numerous other aspects are described.

### CROSS-REFERENCE TO RELATED APPLICATION

This patent application claims priority to U.S. Provisional Patent Application No. 63/585,031, filed on Sep. 25, 2023, entitled “TECHNIQUES FOR ADAPTATION OF HYBRID AUTOMATIC REPEAT REQUEST RETRANSMISSION HANDLING,” and assigned to the assignee hereof. The disclosure of the prior Application is considered part of and is incorporated by reference into this patent application.

### FIELD OF THE DISCLOSURE

Aspects of the present disclosure generally relate to wireless communication and to techniques and apparatuses for an adaptation of hybrid automatic repeat request (HARQ) retransmission handling.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include obtaining hybrid automatic repeat request (HARQ) information associated with a network node, wherein the HARQ information indicates whether the network node is configured to perform a retransmission of an indication of a modulation and coding scheme (MCS) prior to an end of HARQ processes associated with the network node. The method may include receiving, for a HARQ process associated with a downlink communication from the network node, a retransmission of a transport block (TB) of the downlink communication, wherein the retransmission is associated with a reserved MCS and full decoding information for the TB is unavailable. The method may include performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

Some aspects described herein relate to an apparatus for wireless communication at a UE. The apparatus may include one or more memories and one or more processors coupled to the one or more memories. The one or more processors may be individually or collectively configured to obtain HARQ information associated with a network node, wherein the HARQ information indicates whether the network node is configured to perform a retransmission of an indication of an MCS prior to an end of HARQ processes associated with the network node. The one or more processors may be individually or collectively configured to receive, for a HARQ process associated with a downlink communication from the network node, a retransmission of a TB of the downlink communication, wherein the retransmission is associated with a reserved MCS and full decoding information for the TB is unavailable. The one or more processors may be individually or collectively configured to perform, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

Some aspects described herein relate to a non-transitory computer-readable medium that stores a set of instructions for wireless communication by a UE. The set of instructions, when executed by one or more processors of the UE, may cause the UE to obtain HARQ information associated with a network node, wherein the HARQ information indicates whether the network node is configured to perform a retransmission of an indication of an MCS prior to an end of HARQ processes associated with the network node. The set of instructions, when executed by one or more processors of the UE, may cause the UE to receive, for a HARQ process associated with a downlink communication from the network node, a retransmission of a TB of the downlink communication, wherein the retransmission is associated with a reserved MCS and full decoding information for the TB is unavailable. The set of instructions, when executed by one or more processors of the UE, may cause the UE to perform, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

Some aspects described herein relate to an apparatus for wireless communication. The apparatus may include means for obtaining HARQ information associated with a network node, wherein the HARQ information indicates whether the network node is configured to perform a retransmission of an indication of an MCS prior to an end of HARQ processes associated with the network node. The apparatus may include means for receiving, for a HARQ process associated with a downlink communication from the network node, a retransmission of a TB of the downlink communication, wherein the retransmission is associated with a reserved MCS and full decoding information for the TB is unavailable. The apparatus may include means for performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

Some aspects described herein relate to a method of wireless communication performed by a UE. The method may include receiving, for a HARQ process associated with a downlink communication from a network node, a retransmission of a transport block (TB) of the downlink communication, wherein the retransmission is associated with a reserved MCS and full decoding information for the TB is unavailable. The method may include transmitting, to the network node and based on the reception of the retransmission, a HARQ feedback communication indicating that the full decoding information is unavailable.

Some aspects described herein relate to an apparatus for wireless communication at a UE. The apparatus may include one or more memories and one or more processors coupled to the one or more memories. The one or more processors may be individually or collectively configured to receive, for a HARQ process associated with a downlink communication from a network node, a retransmission of a TB of the downlink communication, wherein the retransmission is associated with a reserved MCS and full decoding information for the TB is unavailable. The one or more processors may be individually or collectively configured to transmit, to the network node and based on the reception of the retransmission, a HARQ feedback communication indicating that the full decoding information is unavailable.

Some aspects described herein relate to a non-transitory computer-readable medium that stores a set of instructions for wireless communication by a UE. The set of instructions, when executed by one or more processors of the UE, may cause the UE to receive, for a HARQ process associated with a downlink communication from a network node, a retransmission of a TB of the downlink communication, wherein the retransmission is associated with a reserved MCS and full decoding information for the TB is unavailable. The set of instructions, when executed by one or more processors of the UE, may cause the UE to transmit, to the network node and based on the reception of the retransmission, a HARQ feedback communication indicating that the full decoding information is unavailable.

Some aspects described herein relate to an apparatus for wireless communication. The apparatus may include means for receiving, for a HARQ process associated with a downlink communication from a network node, a retransmission of a TB of the downlink communication, wherein the retransmission is associated with a reserved MCS and full decoding information for the TB is unavailable. The apparatus may include means for transmitting, to the network node and based on the reception of the retransmission, a HARQ feedback communication indicating that the full decoding information is unavailable.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of redundancy versions, in accordance with the present disclosure.

FIGS. 5A and 5B are diagrams of an example associated with adaptation of hybrid automatic repeat require (HARQ) retransmission handling, in accordance with the present disclosure.

FIG. 6 is a diagram of an example process associated with adaptation of a HARQ operation mode, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

### DETAILED DESCRIPTION

In hybrid automatic repeat request (HARQ) processes, an initial transmission associated with a first redundancy version of a transport block (TB) may be transmitted to a receiver followed by one or more retransmissions associated with different redundancy versions (RVs) of the same TB. For example, the first redundancy version may be RV 0 and the different redundancy versions may be RV 2, RV 3, and RV 1, respectively. In some examples, a modulation and coding scheme (MCS) may be indicated to the receiver via RV 0, such that the MCS may not be re-indicated to the receiver via the one or more retransmissions associated with RV 2, RV 3, and RV 1. Instead, the different redundancy versions may be associated with a reserved MCS that corresponds to a same MCS as used for RV 0 (e.g., to reduce a size of the different redundancy versions). However, if RV 0 is not successfully received (e.g., is lost and/or undetermined) by the receiver, the reserved MCS corresponding to the MCS of RV 0 may not be determined by the UE. Therefore, the UE may be unable to decode the one or more different redundancy versions, such as RV 2, RV 3, and/or RV 1. As a result, continuing to retransmit the one or more different redundancy versions to the receiver needlessly consumes resources when the one or more different redundancy versions cannot be decoded by the receiver due to RV 0 being unsuccessfully received.

The receiver may be configured to transmit, to a transmitter, a HARQ acknowledgement (ACK) when a HARQ transmission/retransmission is successfully received and decoded by the receiver. The receiver may be configured to transmit, to the transmitter, a negative acknowledgement (NACK) when the HARQ transmission/retransmission is not successfully received and decoded by the receiver. If the transmitter does not receive an ACK or a NACK from the receiver, the transmitter may determine that discontinuous transmission (DTX) has occurred and proceed with retransmission of a next redundancy version (e.g., RV 2). Therefore, if the receiver is expecting to receive RV 0, but RV 0 is not successfully received, then the receiver may unexpectedly receive RV 2. An unexpected reception of RV 2 may indicate to the receiver that RV 0 was lost, which may thereby cause the receiver to transmit a “forced” ACK to the transmitter. The forced ACK may terminate additional HARQ retransmissions associated with the remaining different redundancy versions of the TB to reduce wasted resources that may result from the receiver not being able to decode the additional HARQ retransmissions associated with the remaining different redundancy versions of the TB.

However, in some cases, if the transmitter detects that a number (quantity) of NACK indications associated with a HARQ process satisfies a threshold, then the transmitter may fall back to retransmitting the information associated with decoding the TB, such as an indication of the MCS and/or a physical resource block (PRB) allocation, among other examples. For example, if the transmitter detects DTX and determines that the number of NACK indications associated with the HARQ process satisfies the threshold, then the transmitter may fall back to retransmitting the RV 0 (or another RV with the information for decoding the TB). For example, the transmitter may transmit an RV 0. The receiver may not successfully detect, decode, or otherwise receive the RV 0. The transmitter may detect DTX and may transmit an RV 2 with a reserved MCS that may be received by the receiver. However, because the receiver is unable to decode the RV 2, the receiver may transmit, and the transmitter may receive, a NACK (e.g., a HARQ NACK). The receiver may continue to transmit NACKs for subsequent RV receptions. The transmitter may determine that the number of NACK indications satisfies the threshold. As a result, the transmitter may transmit an RV (e.g., an RV 0 or another RV) that includes information associated with decoding the RVs (e.g., an MCS and/or PRB allocation). This may enable the receiver and/or the transmitter to recover the HARQ process and decode the TB without radio link control (RLC) level retransmissions. Enabling the HARQ process to be received and/or reducing a likelihood of RLC retransmissions may reduce latency and conserve resources associated with receiving the TB.

However, the receiver may not receive an indication of a HARQ operation or configuration that is being used at the transmitter. For example, the receiver may not know whether the transmitter is configured to fall back to retransmitting the indication of the MCS and/or other information after a given number of NACK indications. Therefore, in some cases, the receiver may not transmit a forced ACK and the transmitter may not be configured to fall back to retransmitting the indication of the MCS and/or other information after a given number of NACK indications, resulting in resources being consumed in association with transmitting RVs that the receiver is unable to decode. In other examples, the receiver may transmit the forced ACK and the transmitter may be configured to fall back to retransmitting the indication of the MCS and/or other information after a given number of NACK indications. However, the receiver may transmit the forced ACK before the given number of NACK indications are transmitted, resulting in RLC retransmission for the TB that could have otherwise been received and/or recovered during the HARQ process.

Various aspects relate generally to wireless communication and more particularly to HARQ procedures. Some aspects more specifically relate to adaptive forced ACK transmissions for HARQ procedures. For example, a receiver (e.g., a user equipment (UE) or a network node) may obtain information associated with a HARQ operation of a transmitter (e.g., a network node or a UE). For example, the receiver may perform one or more HARQ processes with the transmitter to obtain the indication. The information may indicate whether the HARQ operation includes retransmitting an indication of an MCS (and/or other information associated with a decoding operation at the receiver) prior to an end of each HARQ process. For example, the information may indicate whether the transmitter is associated with a NACK-based retransmission of the MCS during a given HARQ process. In some aspects, the information may include an indication of a number of NACK indications that triggers the transmitter to retransmit the information associated with a decoding operation at the receiver, such as the MCS and/or a PRB allocation, among other examples.

For example, during a “learning” phase, the receiver may perform one or more HARQ processes with the transmitter to obtain the information, as described in more detail elsewhere herein. During an “adaptation” phase, the receiver may adapt one or more HARQ operations of the receiver. For example, the receiver may adapt a forced ACK operation based on the information. For example, if the information indicates that the transmitter does not retransmit an indication of an MCS (and/or other information associated with a decoding operation at the receiver) prior to an end of each HARQ process if a number of NACK indications satisfies a threshold, then the receiver may transmit a forced ACK based on receiving an unexpected RV and/or based on receiving an RV with a reserved MCS prior to the receiver receiving an indication of the MCS. If the information indicates that the transmitter does retransmit an indication of an MCS (and/or other information associated with a decoding operation at the receiver) prior to an end of each HARQ process if a number of NACK indications satisfies a threshold, then the receiver may adapt the forced ACK operation to only transmit the forced ACK after the number of NACK indications have been transmitted.

In some aspects, the receiver may transition between the learning phase and the adaptation phase based on, in response to, or otherwise associated with detecting an event. For example, the event may include receiving configuration information, detecting a change in cell information, detecting a change in a subcarrier spacing (SCS) used, detecting that a retransmission of the MCS did not arrive when expected, performing a handover operation, receiving a radio bearer configuration, receiving an RLC configuration, detecting a change in quality of service (QOS) parameters, and/or detecting a change in a protocol data unit (PDU) session type, among other examples. Additionally, or alternatively, the receiver may transition between the learning phase and the adaptation phase based on, in response to, or otherwise associated with a periodic schedule. For example, the receiver may periodically switch between the learning phase and the adaptation phase.

In some aspects, the receiver may transmit, for a HARQ process, a HARQ feedback communication indicating that full decoding information for a TB is unavailable. For example, the receiver may receive a retransmission of the TB, where the retransmission is associated with a reserved MCS. The receiver may determine that full decoding information for the TB is unavailable at the receiver. Therefore, the receiver may transmit the HARQ feedback communication indicating that the full decoding information for the TB is unavailable. For example, the HARQ feedback communication may be associated with a HARQ state that indicates lost decoding information.

Some aspects of the subject matter described in this disclosure can be implemented to realize one or more of the following potential advantages. In some aspects, by adapting a forced ACK transmission operation for HARQ procedures, the receiver may be enabled to transmit the forced ACK for early termination of a HARQ process based on the transmitter not being configured to retransmit an indication of the MCS during the HARQ process and/or only after the retransmission of the MCS is expected. This may conserve processing resources and/or network resources that would have otherwise been used to transmit and/or receive RVs during a HARQ process that the receiver is unable to decode. Additionally, this may enable the receiver to receive and/or decode a TB during a HARQ process when the transmitter is configured to retransmit the indication of the MCS during the HARQ process. This may reduce a likelihood of an RLC retransmission for the TB, thereby reducing latency and conserving resources (e.g., processing resources and/or network resources) that would have otherwise been associated with the RLC retransmission.

Additionally, by performing one or more operations associated with the learning phase, the receiver may be enabled to adapt the forced ACK transmission operation for HARQ procedures to the HARQ operation of the transmitter which the receiver is communicating. By switching between the learning phase and the adaptation phase (e.g., periodically and/or based on detecting an event), an accuracy of the information for the HARQ operation of the transmitter may be improved, thereby improving an effectiveness of the adaptation of the forced ACK transmission operation of the receiver.

By transmitting the HARQ feedback communication indicating that full decoding information for a TB is unavailable (e.g., in response to receiving a retransmission of the TB that is associated with a reserved MCS), the receiver may indicate to the transmitter that a retransmission of the full decoding information is requested. This may enable the transmitter to identify when the receiver has missed or lost the full decoding information for a given HARQ process. As a result, latency associated with the communication of the TB may be reduced (e.g., because the receiver may quickly obtain the full decoding information after missing the full decoding information). Further, this may conserve network resources, processing resources, and/or power resources, among other examples, that would have otherwise been associated with the communication of retransmissions of the TB that cannot be decoded by the receiver and/or the communication of one or more NACK feedback indications in response to the retransmissions of the TB that cannot be decoded by the receiver.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

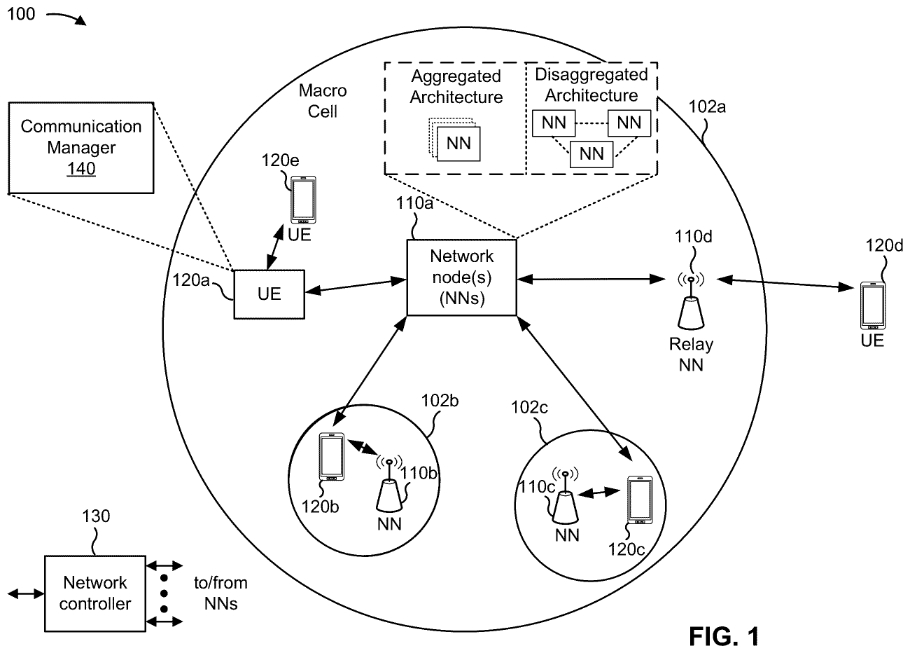

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a given geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a given RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHZ-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may obtain HARQ information, wherein the HARQ information indicates whether the network node is configured to perform a retransmission of an indication of a MCS prior to an end of HARQ processes associated with the network node; receive, for a HARQ process associated with a downlink communication from the network node, a retransmission of a TB of the downlink communication, wherein the retransmission is associated with a reserved MCS and full decoding information for the TB is unavailable; and perform, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process. Additionally, or alternatively, the communication manager 140 may receive, for a HARQ process associated with a downlink communication from a network node, a retransmission of a TB of the downlink communication, wherein the retransmission is associated with a reserved MCS and full decoding information for the TB is unavailable; and/or transmit, to the network node and based on the reception of the retransmission, a HARQ feedback communication indicating that the full decoding information is unavailable. Additionally, or alternatively, the communication manager 140 may perform one or more other operations described herein.

As indicated above, FIG. 1 is provided as an example. Other examples may differ from what is described with regard to FIG. 1.

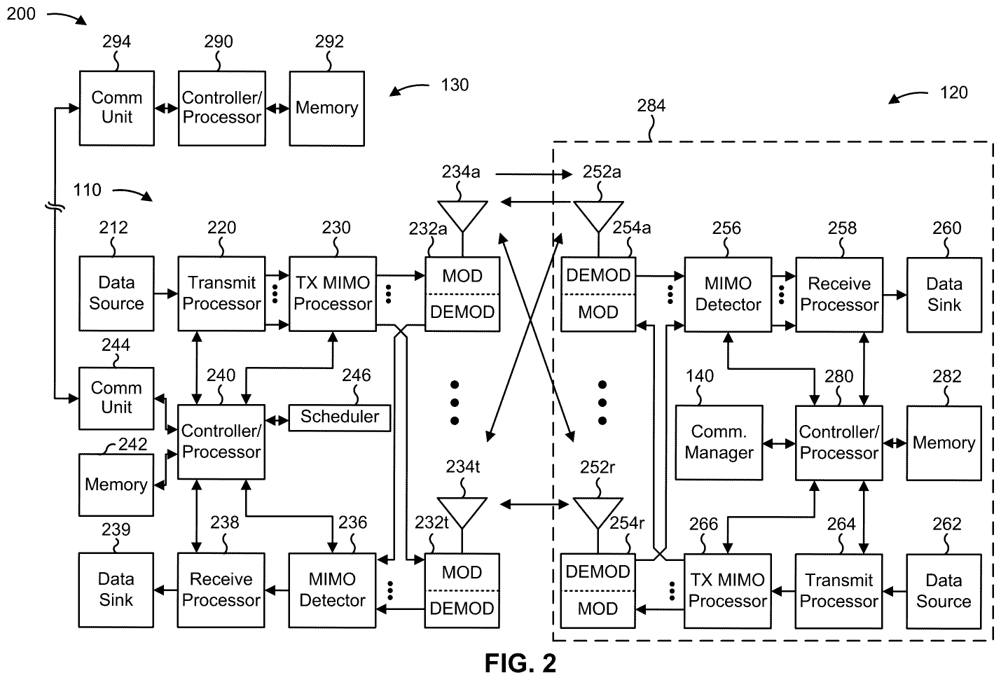

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

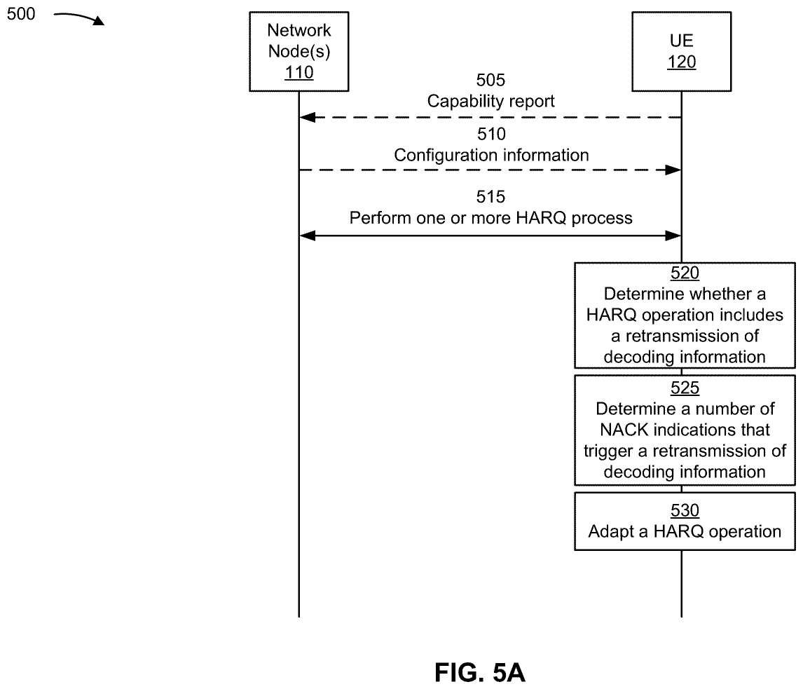

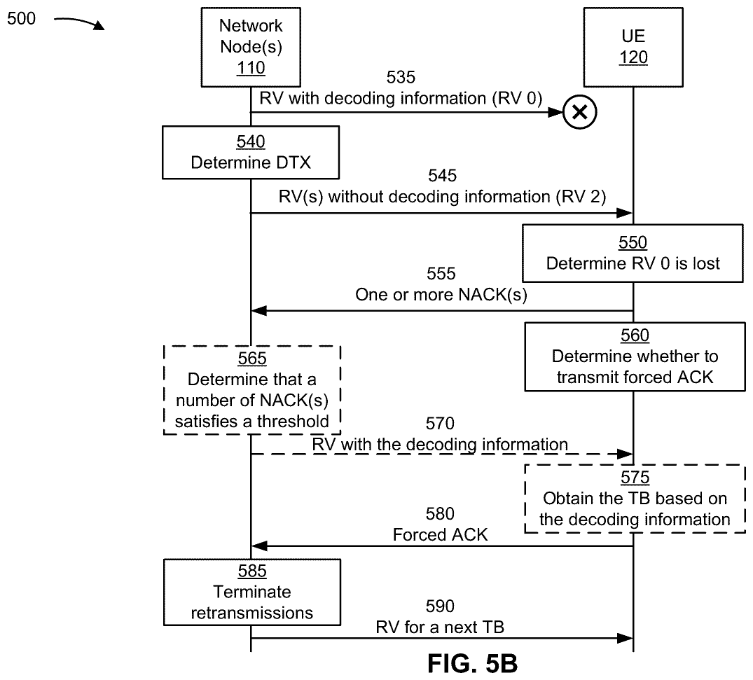

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 5A, 5B, and 6-8).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 5A, 5B, and 6-8).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

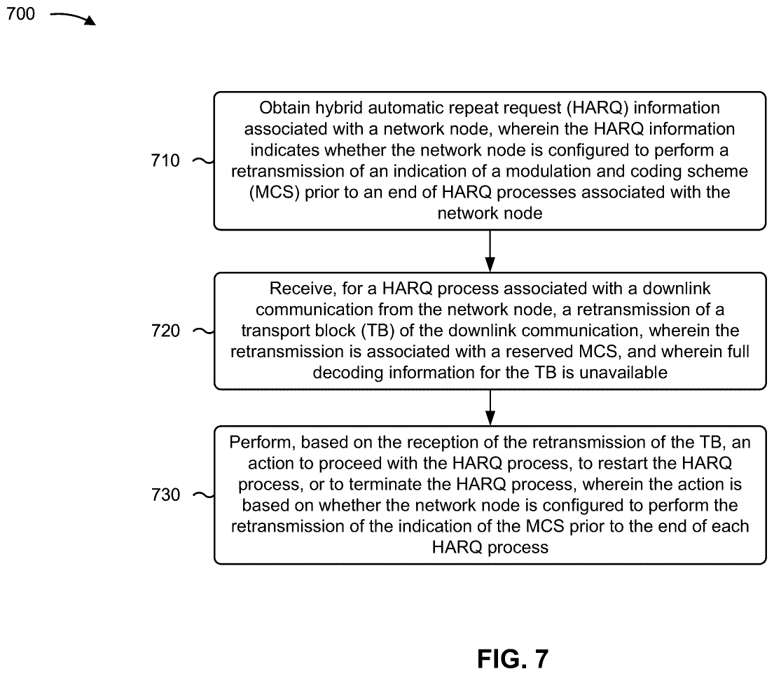

The controller/processor 240 of the network node 110, the controller/processor 280 of the UE 120, or any other component(s) of FIG. 2 may perform one or more techniques associated with adaptation of HARQ retransmission handling, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, the UE 120 includes means for obtaining HARQ information, wherein the HARQ information indicates whether the network node is configured to perform a retransmission of an indication of an MCS prior to an end of HARQ processes associated with the network node; means for receiving, for a HARQ process associated with a downlink communication from the network node, a retransmission of a TB of the downlink communication, wherein the retransmission is associated with a reserved MCS and full decoding information for the TB is unavailable; and/or means for performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process. Additionally, or alternatively, the UE 120 includes means for receiving, for a HARQ process associated with a downlink communication from a network node, a retransmission of a TB of the downlink communication, wherein the retransmission is associated with a reserved MCS and full decoding information for the TB is unavailable; and/or means for transmitting, to the network node and based on the reception of the retransmission, a HARQ feedback communication indicating that the full decoding information is unavailable. The means for the UE 120 to perform operations described herein may include, for example, one or more of communication manager 140, antenna 252, modem 254, MIMO detector 256, receive processor 258, transmit processor 264, TX MIMO processor 266, controller/processor 280, and/or memory 282, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

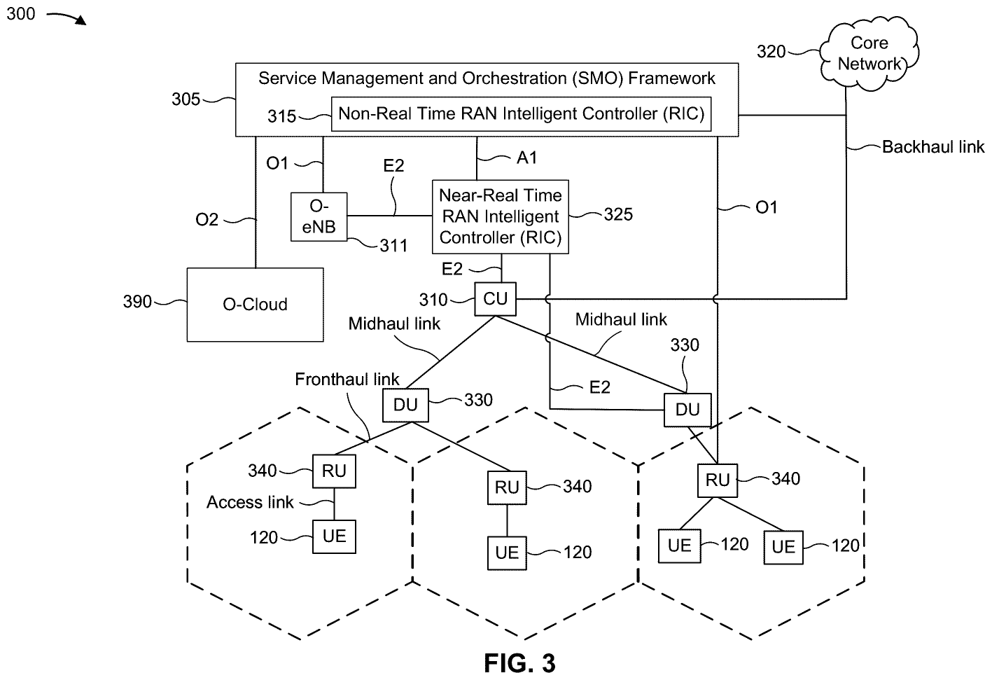

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of an RLC layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

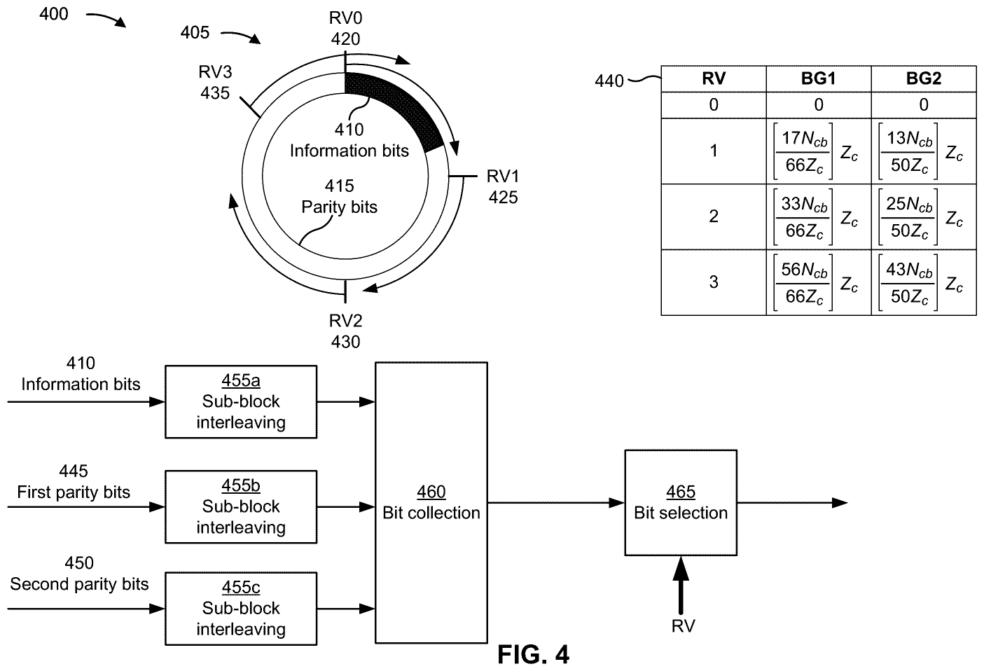

FIG. 4 is a diagram illustrating an example 400 of redundancy versions, in accordance with the present disclosure. A UE 120 may apply redundancy version cycling to uplink communications (e.g., physical uplink shared channel (PUSCH) repetitions) to transmit different redundancy versions of the PUSCH repetition in different transmission occasions. Additionally, or alternatively, a network node 110 may apply redundancy version cycling to downlink repetitions to transmit different redundancy versions of a transmission (e.g., of a TB) in different transmission occasions.

“Redundancy version” (RV) of a repetition refers to a set of encoded bits that are transmitted for that repetition. Using RV cycling, a wireless communication device (e.g., the UE 120 and/or the network node 110) may transmit a different set of encoded bits in different repetitions. For example, the wireless communication device may store bits for a transmission (e.g., for one or more TBs) in a circular buffer 405 (e.g., stored in memory of the wireless communication device). The circular buffer 405 may store information bits 410 (sometimes referred to as systematic bits) and parity bits 415 (sometimes referred to as parity-check bits). The information bits 410 may include the data to be transmitted, and the parity bits 415 may include linear combinations of the data (e.g., of the information bits 410). The wireless communication device may encode information bits 410, parity bits 415, or a combination of information bits 410 and parity bits 415 into a set of encoded bits, and may transmit the set of encoded bits. The given bits that are selected to be included in the set of encoded bits for a repetition may depend on (or may be defined by) the RV of that repetition.

As an example, the starting bit locations may be defined by a table 440, such as for NR HARQ using low-density parity-check (LDPC) code. The table 440 defines starting bit locations in the circular buffer 405 for a first base graph (BG1) and a second base graph (BG2). A base graph is a parameter for determining parity bits 415 for a transmission based at least in part on a TB size and a code rate (with BG1 being intended for TBs with a larger TB size, and BG2 being intended for TBs with a smaller TB size). Referring to the table, N_{cb} represents the length of the circular buffer 405 (e.g., the number of bits included in the circular buffer 405), and Z_{c} represents a lifting size, which is based at least in part on the number of information bits 410 and the number of base graph (BG) columns corresponding to information bits 410.

For channel encoding in wireless communication, multiple logical procedures may be performed by the wireless communication device for TBs, such as segmentation, and/or cyclic redundancy check (CRC) concatenation, among other examples. In some examples, after symbols/bits are prepared for encoding, the bits may be provided for sub-block interleaving 455a-c, bit collection 460, and bit selection 465 (e.g., as an intermediate procedure of a physical layer procedure). A turbo encoder may execute logic to generate/output the information bits 410 (e.g., systematic bits), first parity bits 445, and second parity bits 450. The bits may be subjected to FEC mechanisms. The first parity bits 445 and the second parity bits 450 are provided as examples of the parity bits 415. In some examples, the encoding operation may include more parity bits or fewer parity bits than depicted in FIG. 4.

The wireless communication device may generate streams of data for respective sub-block interleavers. For example, the turbo encoder may output three separate streams of data for sub-block interleaving 455a-c. After the information bits 410 and the parity bits (e.g., the first parity bits 445 and the second parity bits 450) are separately interleaved, the bits may be received by the circular buffer 405 based on first providing all of the information bits 410 to the circular buffer 405 and then providing the first parity bits 445 and the second parity bits 450 to the circular buffer 405 in an alternating manner. For example, the information bits 410 may be first provided to the circular buffer 405 based on the scheme [S1, S2, . . . , Sk] followed by providing the parity bits based on the scheme [P1(1), P1(2), P2(1), P2(2), . . . , Pk(1), Pk(2)], such that the parity bits provided to the circular buffer 405 alternate between the first parity bits 445 and the second parity bits 450. Each of the individually interleaved steams of data may be maintained in the circular buffer 405, from which the data may be retrieved for transmission.

A HARQ procedure may be used for packet transmission in the physical layer. More specifically, if a NACK is received in response to a packet transmission, the HARQ procedure may provide for more rapid retransmission of the packet in comparison to a level two retransmission. Repeated retransmission of a same packet may be referred to as chase combining. When a different pattern of bits is transmitted for decoding a previous symbol, the process may be referred to as incremental redundancy. For incremental redundancy, a symbol (e.g., a physical downlink shared channel (PDSCH) symbol) may not be discarded based on unsuccessful decoding (e.g., by a UE 120 that receives the symbol). The symbol for a same HARQ bit may be preserved for superimposing the symbol via FEC to recover the symbol. The circular buffer 405 may therefore provide increased performance with low implementation complexity.

The bit selection 465 may be used to extract consecutive bits from the circular buffer 405 to match a number of bits corresponding to resource blocks (RBs) of a transmission. For example, when a downlink communication is scheduled, a certain number of RBs, bits, and/or modulation characteristics may be assigned to the downlink communication. The number of bits that may be included in a corresponding resource allocation may then be selected and transmitted from the circular buffer 405. An exact set of bits to be extracted for transmission may depend on an RV, which may further depend on different starting locations from the circular buffer 405. For instance, the bits selected from the circular buffer 405 may depend on the RV that is transmitted at that point in time (e.g., RV 0 and RV 1 may respectively start and end at different locations associated with the circular buffer 405).

In some examples, a transmission of a TB may be based on four different RVs, which may correspond to RV 0 420, RV 1 425, RV 2 430, and RV 3 435. During transmission, an RV may be selected by a scheduler and provided to a receiver based on signaling or a predefined sequence. The transmitted RV may be configurable and/or dynamic. For example, a UE 120 may execute a command for transmitting in the uplink, but in downlink a network node 110 may override the command even if the network node 110 executes a similar technique as the UE 120. An example RV model may be associated with a sequence of RV 0, RV 2, RV 3, RV 1 (e.g., in that order). After RV 1 is transmitted, there may be no further RVs for the TB, such that transmission of a next TB may be performed following RV 1. In some examples, the sequence for the RV model may be controlled by the network node 110 via downlink control information (DCI).

If RV 0 is received in the downlink and the UE does not successfully decode the associated code blocks/symbols, then the UE 120 may indicate a NACK to the network in the uplink. If RV 0 is not successfully received and/or decoded (e.g., a HARQ MAC TB 0 is transmitted but RV 0 is undetermined), then the UE 120 may not be able to decode other RVs that follow RV 0 (e.g., for that HARQ process and/or for that TB). In other words, if RV 0 is not decoded in the downlink (e.g., due to failed physical downlink control channel (PDCCH) decoding for which scheduling may not be determined or due to tune-away, block error rate (BLER), and/or connected-mode discontinuous reception (CDRX) configuration failures), then the UE 120 may not indicate HARQ feedback in the uplink and the network may assume DTX. More specifically, if the UE 120 does not provide an ACK or a NACK, then the network node 110 may determine that DTX has occurred. In examples where the UE 120 decodes the PDCCH, but fails to decode the PDSCH, the PDSCH symbols may be preserved for recovery techniques. If the UE 120 fails to recover the PDSCH symbols, the UE 120 may transmit a NACK. For both cases of NACK/DTX, the network node 110 may retransmit the MAC TB using other redundancy versions (e.g., RV 2, RV 3, RV 1) in subsequent downlink transmissions to enable HARQ level recovery at the receiver by increasing FEC opportunities.

If the UE 120 completely misses RV 0 in the downlink (e.g., RV 0 is lost), even with successful decoding of other RVs (e.g., RV 2, RV 3, RV 1), the UE 120 may not be able to reliably decode the complete MAC TB due to information bits 410 in RV 0 being lost. Thus, even though RV 0 may be recovered in some cases, the UE 120 may abort HARQ retransmission logic when RV 0 is determined to be lost based on configuration information. For example, continuing to decode/schedule subsequent HARQ retransmissions by the UE 120 and the network node 110 may not be practical with respect to the MAC TB after RV 0 is lost. In addition, continuing to perform such procedures may result in wasted resources by subsequent retransmissions that reduce an overall capacity of the physical layer and/or cause delayed transmissions for subsequent data from the MAC in subsequent instances of the HARQ procedure.

For example, the RV 0 may include information associated with decoding a transmission (e.g., a TB). For example, the RV 0 may include an indication of an MCS associated with the TB (e.g., sometimes referred to as a “clear” MCS), an indication of an RB allocation within a bandwidth or bandwidth part (BWP) (e.g., may include an indication of PRBs associated with the TB), and/or other information associated with decoding the transmission. Other RVs (e.g., RV 1, RV 2, and/or RV 3) may not include the information associated with decoding the transmission. For example, the other RVs may indicate a reserved MCS. “Reserved MCS” refers to an MCS (or an MCS index) that indicates that a previously indicated MCS (e.g., indicated via RV 0) is to be used to decode the transmission. For example, an RV 1 may include a reserved MCS that indicates that the RV 1 is to be decoded using a previously indicated (e.g., indicated by the RV 0). This may reduce a size of the other RVs (e.g., that include the reserved MCS(s)) because the reserved MCS may have a smaller size (e.g., may use fewer bits) than the indication of the MCS (e.g., the clear MCS). However, if a receiver (e.g., the UE 120 or the network node 110) does not receive the RV that includes the indication of the MCS (e.g., the RV 0), then the receiver may be unable to decode subsequent RVs (e.g., even if the subsequent RVs are received by the receiver) because the receiver may not know which MCS is to be used to decode the subsequent RVs.

In some examples, when a UE determines for a given HARQ procedure or process that RV 0 is lost, the UE may abort a HARQ retransmission request by indicating an ACK indication to a network node 110. Such ACK indications may be referred to as “forced” ACK indications. A forced ACK indication may enable the network node 110 to proceed to a next HARQ procedure for transmission of a next MAC TB. In some aspects, the next HARQ procedure may be performed while lost information for the previous HARQ is recovered through an RLC level automatic repeat request (ARQ), if the UE 120 is configured with an RLC ARQ mode. The RLC may request retransmission of packets at the RLC level, which may reduce latency in comparison to waiting for the MAC to recover. For certain coding rates at the MAC TB level, the UE 120 may be able to successfully recover. The UE 120 may determine, based on the coding rate, physical characteristics, and/or information indicated via DCI (e.g., MCS, RV instances, or other information), where the forced ACK may be provided to the network in the uplink.

The UE 120 may transmit a forced ACK indication when subsequent retransmissions, such as RV 2, RV 3, and RV 1, use a reserved MCS (e.g., when RV 0 is lost and the MCS is indicated by the network node 110 via the RV 0). For example, an MCS may be indicated to the UE 120 based on transmission of RV 0 and may not be re-indicated to the UE 120 at a transmission time of RV 2, RV 3, or RV 1. Instead, subsequent RVs may be associated with the reserved MCS that corresponds to a same MCS as used for RV 0. However, if RV 0 is lost, the UE 120 may be unable to determine the MCS for decoding RV 2, RV 3, and RV 1. Thus, even if the UE 120 were to successfully receive RV 2, RV 3, and/or RV 1, the UE 120 may not have sufficient information to identify the MCS for retransmission based on the failed decoding of RV 0. Therefore, decoding errors for the initial transmission corresponding to RV 0 may preclude the UE 120 from being able to decode the remaining RVs.

Even when successful retransmissions of RV 2, RV 3, and RV 1 are associated with a determined MCS, the UE 120 may not be able to decode the retransmissions as a result of the coding rates. For example, an initial transmission may indicate MCS 15 and the retransmissions may indicate a different MCS (e.g., MCS 10 or MCS 8), such that the retransmissions include a determined MCS. In such cases, there may not be a sufficient number of parity bits to perform the decoding, as the number of bits corresponding to the different MCS is reduced. Thus, in some aspects, successful decoding may depend on the code rate. A low coding rate may provide an increased likelihood of successful decoding based on an increased number of parity bits, and a high coding rate may provide a decreased likelihood of successful decoding based on a decreased number of parity bits. High coding rates and additional delay may be avoided when the UE is operating at or near a peak operating rate.

A lower coding rate may correspond to more redundancy bits in the channel coding process and a higher coding rate may correspond to fewer redundancy bits in the channel coding process. In an example based on 16 HARQs, excessive retransmissions may delay a next transmission. For full scheduling, which may assume that every slot is scheduled consecutively, the next transmission/next MAC TB may be delayed by 32 slots (e.g., 16 HARQs×2 wasted/excessive retransmissions). For sparse scheduling, 10 percent of the scheduling may be allocated to the UE, where the next transmission/next MAC TB may be delayed by 320 slots (e.g., 16 HARQs×2 wasted/excessive retransmissions spaced at 1 slot for every 10 slots).

A Layer 2 logic may be improved based on reducing a time for receiving a next MAC TB. Given that the HARQ procedure may be abruptly concluded in some cases, a prompt indication to the RLC that an RLC PDU is lost may decrease latency for the ARQ mechanism or other fast NACK mechanisms. Some configurations may pause for a previous HARQ to complete before triggering the retransmissions. Therefore, an amount of time that memory buffers are maintained at the MAC level may be reduced, which may improve aspects associated with memory management.

In some examples, a network node 110 may assume DTX when RV 0 is lost because no ACK/NACK is received from the UE 120 for the RV 0. However, if RV 2 is received by the UE 120, but is not expected by the UE 120 (e.g., because the RV 0 is not successfully received by the UE 120), there may be no need to perform the retransmissions of RV 3 and RV 1, because the UE 120 may be unable to decode RV 3 and RV 1. Instead, the UE 120 may transmit a forced ACK to the network node 110 so that transmission/reception of the next MAC TB may be performed without any further delay from the remaining retransmissions of a given MAC TB. A delay between a time at which RV 0 is lost and a time at which a next MAC TB is received may be reduced. In some examples, if one or more other RVs of the HARQ is to be received before RV 0 is to be received, the forced ACK may not be transmitted until after the time at which RV 0 is expected (e.g., after RV 0 is lost).

However, in some cases, if a network node 110 detects that a number of NACK indications associated with a HARQ process satisfies a threshold, then the network node 110 may fall back to retransmitting the information associated with decoding the TB, such as an indication of the MCS and/or PRB allocation, among other examples. For example, if the network node 110 detects DTX and determines that the number of NACK indications associated with the HARQ process satisfies the threshold, then the network node 110 may fall back to retransmitting the RV 0 (or another RV with the information for decoding the TB). For example, the network node 110 may transmit an RV 0. The UE 120 may not successfully detect, decode, or otherwise receive the RV 0. The network node 110 may transmit an RV 2 with a reserved MCS that may be received by the UE 120. However, because the UE 120 is unable to decode the RV 2, the UE 120 may transmit, and the network node 110 may receive, a NACK (e.g., a HARQ NACK). The UE 120 may continue to transmit NACKs for subsequent RV receptions. The network node 110 may determine that the number of NACK indications satisfies the threshold. As a result, the network node 110 may transmit an RV (e.g., an RV 0 or another RV) that includes information associated with decoding the RVs (e.g., an MCS and/or PRB allocation). This may enable the UE 120 and/or the network node 110 to recover the HARQ process and decode the TB without RLC level retransmissions. Enabling the HARQ process to be received and/or reducing a likelihood of RLC retransmissions may reduce latency and conserve resources associated with receiving with the TB.

However, the UE 120 may not receive an indication of a HARQ operation or configuration at the network node 110. For example, the UE 120 may not know whether the network node 110 is configured to fall back to retransmitting the indication of the MCS and/or other information after a given number of NACK indications. Therefore, in some cases, the UE 120 may not transmit a forced ACK and the network node 110 may not be configured to fall back to retransmitting the indication of the MCS and/or other information after a given number of NACK indications, resulting in resources being consumed in association with transmitting RVs that the UE is unable to decode. In other examples, the UE 120 may transmit the forced ACK and the network node may be configured to fall back to retransmitting the indication of the MCS and/or other information after a given number of NACK indications. However, the UE 120 may transmit the forced ACK before the given number of NACK indications are transmitted, resulting in RLC retransmission for the TB that could have otherwise been received and/or recovered during the HARQ process.

As indicated above, FIG. 4 is provided as an example. Other examples may differ from what is described with respect to FIG. 4.

FIGS. 5A and 5B are diagrams of an example 500 associated with adaptation of HARQ retransmission handling, in accordance with the present disclosure. As shown in FIGS. 5A and 5B, one or more network nodes 110 (e.g., a base station, a CU, a DU, and/or an RU) may communicate with a UE 120. In some aspects, the network node(s) 110 and the UE 120 may be part of a wireless network (e.g., the wireless network 100). The UE 120 and the network node(s) 110 may have established a wireless connection prior to operations shown in FIGS. 5A and 5B.

In the example 500, the UE 120 may be a receiver and the network node 110 may be a transmitter for one or more HARQ processes. However, in other examples, the UE 120 may be a transmitter and the network node 110 may be a receiver for HARQ processes in a similar manner as described herein. For example, if the UE 120 is a transmitter and the network node 110 is a receiver, then the network node 110 may perform one or more operations described herein as being performed by the UE 120 (e.g., for adapting a HARQ operation). Additionally, or alternatively, if the UE 120 is a transmitter and the network node 110 is a receiver, then the UE 120 may perform one or more operations described herein as being performed by the network node 110 (e.g., for adapting a HARQ operation).

In some aspects, as shown in FIG. 5A and by reference number 505, the UE 120 may transmit, and the network node 110 may receive, a capability report. The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a PUSCH, among other examples. The capability report may indicate one or more parameters associated with respective capabilities of the UE 120. The one or more parameters may be indicated via respective information elements (IEs) included in the capability report.

The capability report may indicate whether the UE supports a feature and/or one or more parameters related to the feature. For example, the capability report may indicate a capability and/or parameter for adapting a HARQ operation of the UE 120 (e.g., based on information of a HARQ operation of the network node 110). As another example, the capability report may indicate a capability and/or parameter for adapting a forced ACK operation of the UE 120 based on information of a HARQ operation of the network node 110. One or more operations described herein may be based on capability information of the capabilities report. For example, the UE may perform a communication in accordance with the capability information, or may receive configuration information that is in accordance with the capability information. In some aspects, the capability report may indicate UE support for adapting a timing of a transmission of a forced ACK indication based on whether the network node 110 is configured to retransmit decoding information (e.g., an MCS, a PRB allocation, or other decoding information) during a given HARQ process, as described in more detail elsewhere herein.

The capability report may indicate how a number of NACK indications (e.g., transmitted by the UE 120 for a given HARQ process) that cause the UE 120 to perform a forced ACK operation, as described in more detail elsewhere herein. The network node 110 may use the indication of the number of NACK indications to determine when to provide a retransmission of the decoding information for a given HARQ process. In some aspects, the UE 120 may transmit the capability report in response to a request from the network node 110. For example, the network node 110 may transmit, and the UE 120 may receive, a request for UE capabilities. The UE 120 may transmit the capability report in response to the request.

In some aspects, the capability report may indicate that the UE 120 supports HARQ feedback indicating that control information or decoding information for a given HARQ process was missed. For example, rather than an ACK or NACK, the UE 120 may transmit feedback information indicating that a retransmission was received, but could not be decoded because the decoding information was not received by the UE 120. Such HARQ feedback may cause the network node 110 to retransmit the decoding information of control information for the given HARQ process.

As shown by reference number 510, the network node 110 may transmit, and the UE 120 may receive, configuration information. In some aspects, the UE 120 may receive the configuration information via one or more of system information (e.g., a master information block (MIB) and/or a system information block (SIB)), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may include a HARQ configuration (e.g., a HARQ process configuration). For example, the configuration information may indicate a number of HARQ processes and/or one or more configuration parameters for the HARQ process (cs). In some aspects, the configuration information may indicate whether a HARQ operation of the network node 110 includes retransmitting an indication of decoding information (e.g., an MCS and/or a PRB allocation) prior to an end of each HARQ process. For example, the configuration information may indicate whether the HARQ operation of the network node 110 includes a NACK-based retransmission of the MCS during a given HARQ process. For example, the network node 110 may be configured to retransmit decoding information during the same HARQ process based on, in response to, or otherwise associated with the network node 110 receiving a number of NACK indications that satisfy a threshold (and/or based on detecting that DTX has occurred). For example, the network node 110 may be configured to fall back to transmitting the RV 0 based on, in response to, or otherwise associated with the network node 110 receiving a number of NACK indications that satisfy the threshold. As another example, the network node 110 may be configured to fall back to transmitting the RV 0 based on, in response to, or otherwise associated with the network node 110 receiving HARQ feedback indicating that control information or decoding information for a given HARQ process was missed. The configuration information may indicate that such an operation is supported by the network node 110. Additionally, the configuration information may indicate one or more parameters for the NACK-based retransmission. For example, the configuration information may indicate a value of the threshold.

In some aspects, the configuration information may indicate that the UE 120 is to adapt a HARQ operation of the UE 120 based on, in response to, or otherwise associated with a HARQ operation of the network node 110. For example, the configuration information may indicate that the UE 120 is to analyze (e.g., “learn”) the HARQ operation of the network node 110 and adapt a forced ACK operation of the UE 120 based on, or otherwise associated with, the HARQ operation of the network node 110, as described in more detail elsewhere herein.

The UE 120 may configure itself based at least in part on the configuration information. In some aspects, the UE 120 may be configured to perform one or more operations described herein based at least in part on the configuration information.

In some aspects, the configuration information described in connection with reference number 510 and/or the capabilities report may include information transmitted via multiple communications. Additionally, or alternatively, the network node may transmit the configuration information, or a communication including at least a portion of the configuration information, before and/or after the UE transmits the capabilities report. For example, the network node may transmit a first portion of the configuration information before the capabilities report, the UE may transmit at least a portion of the capabilities report, and the network node may transmit a second portion of the configuration information after receiving the capabilities report.

The UE 120 may operate in a learning phase or a learning mode associated with analyzing and/or determining information associated with a HARQ operation of the network node 110. During the learning phase or the learning mode, the UE 120 may refrain from transmitting forced ACK indications. For example, as shown by reference number 515, the UE 120 may perform one or more HARQ processes (or HARQ procedure(s)) with the network node 110. The UE 120 may perform the one or more HARQ processes as configured by the network node 110 (e.g., without transmitting forced ACK indications). For example, the UE 120 may perform the one or more HARQ processes as defined, or otherwise fixed, by a wireless communication standard, such as the 3GPP. In some aspects, the UE 120 may disable (or refrain from performing) a forced ACK operation while performing the one or more HARQ processes. For example, the network node 110 may transmit, and the UE 120 may receive, one or more RVs for a TB (e.g., a MAC TB). The UE 120 may transmit feedback information (e.g., HARQ ACK indications and/or HARQ NACK indications) based on whether respective RVs are successfully received and/or decoded by the UE 120.

The UE 120 may obtain HARQ information associated with a HARQ operation of the network node 110 based on performing one or more HARQ procedures with the network node 110. As used herein, “HARQ information” may refer to information associated with one or more HARQ operations of a transmitter, such as the network node 110. For example, the HARQ information may indicate whether the HARQ operation of the network node 110 includes retransmissions of an indication of all decoding information for a HARQ process prior to an end of HARQ processes associated with the network node 110. All of the decoding information required for a HARQ process may be referred to herein as “full decoding information.” The full decoding information may include an MCS, an RB allocation, MIMO layers, and/or a process identifier, among other examples. In other words, the HARQ information may indicate whether the network node 110 is configured to perform of the MCS and RB allocation during a given HARQ procedure or a given HARQ process, for instance based on receiving NACK (i.e., NACK-based retransmission), or based on receiving HARQ feedback indicating that control information or decoding information for a given HARQ process was missed.

In some aspects, the UE 120 may obtain the HARQ information via an AI/ML model. For example, the UE 120 may provide, as an input to the AI/ML model, the information associated with the HARQ operation of the network node 110 (e.g., obtained via performing the performing one or more HARQ procedures). The UE 120 may obtain, as an output from the AI/ML model, the HARQ information. The AI/ML model may be deployed at the UE 120, at the network node 110, at another device (e.g., at a server or via a cloud-based device), and/or in a distributed manner.

As shown by reference number 520, the UE 120 may determine whether the HARQ operation of the network node 110 includes a retransmission of all the decoding information required during a given HARQ process or a given HARQ procedure. For example, the UE 120 may determine whether, during one or more HARQ procedures (e.g., performed as depicted and described in connection with reference number 515), the UE 120 receives a retransmission of decoding information during a given HARQ process or a given HARQ procedure. The full decoding information may include an MCS (e.g., a clear MCS), a PRB allocation, and/or other information used by the UE 120 to decode RVs of a TB during a given HARQ process or HARQ procedure. For example, the UE 120 may determine whether the network node 110 transmits, and the UE 120 receives, a retransmission of an RV 0 (or another RV) during a given HARQ process or a given HARQ procedure.

In some aspects, the HARQ information obtained by the UE 120 may indicate a scheduling pattern associated with a HARQ operation of the network node 110. For example, the scheduling pattern may indicate whether and/or when the network node 110 is configured to retransmit the decoding information during a given HARQ process or a given HARQ procedure. For example, the network node 110 may be configured to transmit a retransmission of the decoding information, during a given HARQ procedure, after receiving K NACK indications during the given HARQ procedure. The HARQ information obtained by the UE 120 may indicate whether the network node 110 transmits a retransmission of the decoding information during a given HARQ procedure. Additionally, the HARQ information obtained by the UE 120 may indicate a number (e.g., K) of NACK indications that trigger the retransmission of the decoding information. For example, the scheduling pattern may indicate a number (e.g., K) of NACK indications during a given HARQ procedure that cause the network node 110 to transmit a retransmission of the decoding information (e.g., that cause the network node 110 to fall back to transmitting the RV 0 or another RV that includes the decoding information). The configuration (K), may be specific to a carrier ID, a range of channel conditions, a shared channel (SCH) spectral efficiency, a signal-to-noise ratio (SNR), an MCS, and/or one or more PDCCH parameters (such as aggregation factors, or beam parameters), among other examples. This ensures that K is fit for the given channel. For instance, if it is unlikely that a PDCCH is lost compared to a PDSCH decoding failure, then the selected value for K may be higher. If the PDCCH channel is indicated as being unreliable, then the value for K may be larger.

For example, as shown by reference number 525, the UE 120 may determine a number of NACK indications, during a given HARQ procedure, that trigger a retransmission of the decoding information. For example, the UE 120 may obtain the HARQ information for one or more HARQ processes and/or one or more HARQ procedures. The UE 120 may identify one or more HARQ procedures during which one or more NACK indications were transmitted by the UE 120. The UE 120 may identify, for the one or more HARQ procedures during which one or more NACK indications were transmitted by the UE 120, the number of NACK indications after which the network node 110 transmits the retransmission of the decoding information. For example, the UE 120 may identify a number of NACK communications, for the HARQ operation, between an initial retransmission of TBs with a reserved MCS ( ) and the retransmission of the indication of all required information for decoding SCH including the MCS ( ). This may enable the UE 120 to identify the scheduling pattern of the HARQ operation at the network node 110. The UE 120 may adapt or adjust a forced ACK operation of the UE 120 based on, in response to, or otherwise associated with the scheduling pattern.

For example, as shown by reference number 530, the UE 120 may adapt a HARQ operation of the UE 120. For example, the UE 120 may adapt a forced ACK operation of the UE 120 based on the HARQ information obtained by the UE 120. For example, if the HARQ information indicates that the HARQ operation of the network node 110 does not include retransmissions of the indication of the MCS prior to the end of each HARQ process (e.g., based on the number of NACK indications satisfying a threshold), then the UE 120 may adapt the forced ACK operation to cause the UE 120 to transmit the forced ACK after receiving a DCI with indicating a reserved MCS when no prior full decoding information was received prior to receiving full decoding information that includes the MCS. In other words, if the network node 110 is not configured to fall back to retransmitting full decoding information including the MCS during a given HARQ process or HARQ procedure, then the UE 120 may configure the HARQ operation of the UE 120 to transmit a forced ACK communication based on detecting DCI including partial decoding information that is insufficient to decode the shared channel, or that the RV 0 of the given HARQ process or HARQ procedure is lost or not successfully received. For example, if the learning phase does not indicate or show that the network node 110 falls back to transmitting another indication of the decoding information during a given HARQ procedure, then the UE 120 may adapt the HARQ operation of the UE 120 to transmit the forced ACK communication based on, in response to, or otherwise associated with detecting a lost or unsuccessfully received RV 0 (or another RV that includes or indicates the decoding information).

As another example, if the HARQ information indicates that the HARQ operation of the network node 110 does include retransmissions of the full decoding information prior to the end of each HARQ process (e.g., based on the number of NACK indications satisfying a threshold, or other methods), then the UE 120 may adapt the forced ACK operation to cause the UE 120 to transmit the forced ACK only after the number of NACK indications have been transmitted by the UE 120. For example, the UE 120 may adapt a forced ACK operation of the UE 120 to cause the UE 120 to transmit the forced ACK communication after transmitting K NACK indications (e.g., to transmit the forced ACK communication in response to a next HARQ retransmission after transmitting K NACK indications if the next HARQ control information does not include the decoding information). For example, if the learning phase indicates that, after K number of HARQ retransmissions, the network node 110 is falling back to transmitting the full decoding information, then the UE 120 may adapt or modify the forced ACK operation of the UE 120 to transmit the forced ACK communication only after K number of HARQ retransmissions for a given cell associated with (or supported by) the network node 110.

Additionally, or alternatively, the adaptation of the forced ACK operation may be based on one or more communication parameters indicated during the learning phase or via the configuration from the network node 110. The one or more communication parameters may include an MCS, a throughput, a CQI, a channel state information (CSI) parameter, and/or another communication parameter. For example, the HARQ information may indicate one or more indices of an MCS for the one or more HARQ processes. The UE 120 may determine whether one or more indices satisfy an MCS threshold (e.g., indicating a high MCS). For example, if the one or more indices satisfy the MCS threshold, then the UE 120 may adapt the forced ACK operation to cause the UE 120 to transmit the forced ACK after receiving an RV of a TB that uses a reserved MCS prior to receiving an RV of the TB that indicates the MCS. For example, at higher MCSs and without the RV 0, the number of information bits lost can be so large that HARQ retransmissions may not result in a successful decode of the TB. Therefore, the UE 120 may transmit the forced ACK communications for higher MCSs because a decoding operation for the TB may not be successful with limited retransmissions. The MCS-based adaptation may be based on how many retransmissions are explored by the network node 110 for a given MCS and/or a HARQ failure pattern (e.g., operations taken by the network node 110 in response to a HARQ failure). For example, the HARQ information may indicate a number of retransmissions from the network node 110 that are typically used for a given MCS.

Additionally, or alternatively, the UE 120 may determine a throughput associated with a communication link between the UE 120 and the network node 110. The throughput may be a downlink throughput. For example, the UE 120 may determine whether the throughput satisfies a throughput threshold. If the downlink throughput satisfies the throughput threshold, then one or more actions performed by the UE 120 (e.g., as described in more detail elsewhere herein) may cause the UE to terminate HARQ processes if the decoding information is not received (e.g., if the RV 0 is lost). If the downlink throughput does not satisfy the throughput threshold, then one or more actions performed by the UE 120 (e.g., as described in more detail elsewhere herein) may cause the UE to proceed with HARQ processes even if the decoding information is not received (e.g., if the RV 0 is lost), such as by following wireless communication standard defined procedure(s) or operations for the HARQ processes. For example, if the downlink throughput does not satisfy the throughput threshold, then the UE 120 may disable (or refrain from performing) a forced ACK operation. If the downlink throughput satisfies the throughput threshold, then the UE 120 may perform the forced ACK operation and/or adapt the forced ACK operation as described elsewhere herein. Alternatively, the UE 120 may adapt the forced ACK operation based on the services and/or applications executing on the UE 120. For example, for services or application associated with low latency and/or high reliability, the UE 120 may adapt the forced ACK operation to have a higher value for the threshold that causes the UE 120 to transmit the forced ACK (e.g., to increase the likelihood of the HARQ operation being successful). For example, for voice (e.g., with RLC unacknowledged mode (UM) configured), the UE 120 may use a large value of K to give a greater opportunity for the HARQ operation to eventually succeed.

As shown in FIG. 5B, and by reference number 535, the network node 110 may transmit a redundancy version for a downlink communication (e.g., for a TB of a downlink communication). For example, the network node 110 may transmit DCI indicating the full decoding information for the HARQ process. In some aspects, the RV may include decoding information for the TB. In some aspects, the network node 110 may transmit an RV 0 for a MAC TB. The full decoding information may not be successfully received by the UE 120. For example, the RV 0 may be lost and/or not received by the UE 120.

As shown by reference number 540, the network node 110 may determine that DTX has occurred based on not receiving an ACK or a NACK in response to the transmission associated with the RV 0 for the MAC TB. For example, because the UE 120 does not receive and/or detect the RV 0, the UE 120 may not transmit HARQ feedback information for the RV 0. Because the network node 110 does not receive HARQ feedback information for the RV 0, the network node 110 may detect or determine that DTX has occurred. Therefore, as shown by reference number 540, the network node 110 may transmit a different RV (such as the RV 2) for the MAC TB. The UE 120 may receive and/or detect the different RV (e.g., the RV 2) of the MAC TB.

As shown by reference number 550, the UE 120 may determine, based on receiving the different RV (e.g., RV 2), that the full decoding information was lost or not successfully received. The UE 120 may determine (e.g., detect) a decoding error for a PDCCH associated with the MAC TB. In some aspects, the UE 120 may determine that the full decoding information (e.g., an MCS and/or a PRB allocation, or other decoding information) has not been successfully received for the MAC TB. For example, the RV 2 may be received by the UE 120 unexpectedly, which may have expected to receive the RV 0 from the network node 110. For example, the different RV (e.g., the RV 2) may not be provided together with full decoding information for the MAC TB. The UE 120 may expect that a first RV, received for a given MAC TB, includes the full decoding information (e.g., an MCS, a PRB allocation, and/or other decoding information) for the given MAC TB. If the first RV received for a given MAC TB (e.g., for a given HARQ process) includes a reserved MCS (e.g., does not include the decoding information), then the UE 120 may determine that an RV that carries the decoding information was lost (e.g., not successfully detected or received by the UE 120).

In some aspects, as shown by reference number 555, the UE 120 may transmit, and the network node 110 may receive, one or more NACK communications for respective RVs associated with the MAC TB. For example, the network node 110 may transmit, and the UE 120 may receive, one or more RVs (e.g., RV 2, RV 1, or RV 3) that are not provided together with full decoding information. Because the UE 120 has not received the decoding information for the MAC TB, the UE 120 may be unable to decode the one or more RVs. Therefore, the UE 120 may transmit one or more NACK communications for respective RVs of the one or more RVs. In some aspects, the UE 120 may transmit the one or more NACK communications based on the HARQ information indicating that the HARQ operation of the network node 110 does include retransmissions of the indication of the MCS prior to the end of each HARQ process (e.g., based on the number of NACK indications satisfying a threshold). For example, as described elsewhere herein, the forced ACK operation of the UE 120 may be adapted or adjusted to only transmit a forced ACK communication after a given number of NACK communications and/or after receiving a given number of RVs or retransmissions of a MAC TB. Alternatively, the UE 120 may transmit the HARQ feedback indicating that the full decoding information for the HARQ process was not received.

As shown by reference number 560, the UE 120 may determine whether to terminate retransmissions associated with remaining RVs of the MAC TB (e.g., based on the determination that the full decoding information and/or the RV 0 is lost). The determination of whether to terminate the retransmissions associated with the remaining RVs may be based on the UE 120 being unable to decode the remaining RVs as a result of non-received decoding information that was included in the lost transmission. For example, if a lost RV transmission indicates full decoding information (e.g., an MCS and/or a PRB allocation), and subsequent HARQ retransmissions, such as RV 2, RV 3, and/or RV 1, indicate a reserved MCS (e.g., MCS 31 or another reserved MCS as defined, or otherwise fixed, by a wireless communication standard, such as the 3GPP), the UE 120 may be unable to decode the subsequent HARQ retransmissions based on the reserved MCS indicating that the UE 120 is to reuse the decoding information (e.g., the MCS) indicated by the RV 0 (e.g., which was lost) to decode the HARQ retransmissions.

The UE 120 may determine whether to terminate retransmissions associated with remaining RVs of the MAC TB based on the HARQ information obtained by the UE 120 (e.g., as described in connection with FIG. 5A). For example, the UE 120 may determine whether to terminate retransmissions associated with remaining RVs of the MAC TB based on whether the network node 110 is configured to retransmit an indication of decoding information (e.g., an MCS and/or PRB allocation) during a given HARQ process or HARQ procedure. For example, if the HARQ information indicates that the network node 110 is not configured to perform a retransmission of an MCS (e.g., of decoding information) prior to an end of a given HARQ process (e.g., based on a number of NACK indications during the given HARQ process), then the UE 120 may perform one or more actions to terminate the HARQ process. For example, if the HARQ information indicates that the network node 110 is not configured to perform a retransmission of an MCS (e.g., of decoding information) prior to an end of a given HARQ process (e.g., based on a number of NACK indication during the given HARQ process), then the UE 120 may determine to terminate retransmissions associated with remaining RVs of the MAC TB.

If the HARQ information indicates that the network node 110 is configured to perform a retransmission of an MCS (e.g., of decoding information) prior to an end of a given HARQ process (e.g., based on a number of NACK indication during the given HARQ process), then the UE 120 may perform one or more actions to proceed with the HARQ process. For example, if the HARQ information indicates that the network node 110 is configured to perform a retransmission of an MCS (e.g., of decoding information) prior to an end of a given HARQ process (e.g., based on a number of NACK indication during the given HARQ process), then the UE 120 may determine to not terminate retransmissions associated with remaining RVs of the MAC TB (e.g., because one or more of the retransmissions may include the decoding information to enable the UE 120 to decode the MAC TB). For example, as described elsewhere herein, the UE 120 may adapt a forced ACK operation of the UE 120 to only transmit a forced ACK communication after a given number of received retransmissions and/or a given number of transmitted NACK indications.

For example, as shown by reference number 565, the network node 110 may determine that a number of NACKs (e.g., a number of NACK indications transmitted by the UE 120 and/or received by the network node 110) for the HARQ process associated with the MAC TB satisfies a threshold. For example, as described elsewhere herein, the UE 120 may adapt a HARQ operation of the UE 120 to not terminate the HARQ process in response to determining that the decoding information (e.g., the RV 0) for the HARQ process is lost (e.g., based on the network node 110 being configured to retransmit an indication of the decoding information prior to the end of the HARQ process, as indicated by the HARQ information). Therefore, as shown by reference number 555, the UE 120 may transmit NACK indications (also referred to as NACK communications) for respective retransmissions (e.g., respective RVs) of the MAC TB that are transmitted by the network node 110. The network node 110 may determine that the number of NACK indications satisfies a threshold. Alternatively, the network node 110 may receive the HARQ feedback indicating that the full decoding information for the HARQ process was not received and the network node 110 perform similar actions as described above (e.g., in response to receiving the HARQ feedback). The network node 110 retransmitting an indication of the full decoding information in response to receiving HARQ feedback indicating that the full decoding information for the HARQ process was not received (e.g., is unavailable) may be referred to herein as “restarting” the HARQ process. For example, the reception of a HARQ feedback communication indicating that full decoding information for a TB is unavailable may cause the network node 110 to “restart” the HARQ process by transmitting the retransmission of the full decoding information (e.g., via DCI and/or an RV of the TB).

Therefore, as shown by reference number 570, the network node 110 may transmit a retransmission of the MAC TB (e.g., may transmit an RV) that includes the decoding information associated with the MAC TB. In addition, the network node 110 may fall back to transmitting the RV 0 based on the number of NACK indications for the HARQ process satisfying the threshold. As shown by reference number 575, the UE 120 may obtain the TB (e.g., the MAC TB) based on the decoding information (e.g., based on receiving the decoding information). For example, the UE 120 may obtain the decoding information (e.g., the MCS and/or the PRB allocation) that is retransmitted by the network node 110 (e.g., as shown by reference number 570). The UE 120 may use the decoding information to decode and/or combine one or more received retransmissions to obtain the TB.

For example, the UE 120 may additionally store, based on the network node 110 being configured to perform the retransmission of the indication of the MCS prior to the end of each HARQ process, baseband samples (e.g., in-phase (I) and quadrature (Q) (I/Q) samples) associated with one or more retransmissions of the TB (e.g., that are received by the UE 120 prior to receiving the decoding information), such as the one or more retransmissions as shown by reference number 545. For example, the samples may be associated with a full bandwidth size and/or a BWP size. In other words, because the UE 120 has not received the decoding information, the UE 120 may not know where in the bandwidth and/or BWP the retransmission is located. Therefore, the UE 120 may store all I/Q samples for the bandwidth or BWP (e.g., to be used for combining after the UE 120 receives the retransmission of the decoding information).

The UE 120 may receive another RV of the TB that includes the retransmission of the indication of the decoding information (e.g., as shown by reference number 570). The UE 120 may obtain, based on the decoding information, the other RV, and the retransmission of the TB, the TB. For example, the UE 120 may extract relevant information from the stored I/Q samples based on a PRB allocation indicated by the decoding information. The UE 120 may use the extracted I/Q samples, the MCS, and/or any other received RVs or retransmissions to obtain the TB (e.g., using soft combining). The network node 110 may transmit, and the UE 120 may receive, DCI including full decoding information for the current transmission as well as for the previous transmission. For example, the network node 110 may determine one or more RVs that have been transmitted for a given HARQ process and/or for a given TB. The network node 110 may determine the full decoding information based on the transmitted RVs. For example, a first transmission may be RV 0 for a TB and a previous transmission may be RV 1 for the TB. The UE 120 may use the full decoding information to combine the RVs appropriately. In other examples, the UE 120 may assume the previous (stored) transmission is associated with a specific RV, according to a known sequence. The UE 120 may also perform a blind decoding operation, with all possible RV assumptions. The UE may also use only the most recent data received for the blind decoding operation.

In some other aspects, as shown by reference number 580, the UE 120 may transmit, and the network node 110 may receive, a forced ACK communication (e.g., to terminate the HARQ process and/or to terminate retransmissions associated with the HARQ process). For example, the UE 120 may perform one or more actions to terminate the HARQ process. In some aspects, the UE 120 may transmit the forced ACK operation based on determining (e.g., based on the HARQ information) that the network node 110 is not configured to perform or transmit a retransmission of decoding information during a given HARQ process or HARQ procedure. For example, the UE 120 may determine that the UE 120 is unable to decode the remaining RVs as a result of non-received full decoding information. Because the HARQ information indicates that the network node 110 is not configured to retransmit the decoding information during the HARQ process, the UE 120 may transmit the forced ACK communication to cause the network node 110 to terminate retransmissions for the HARQ process (e.g., to conserve resources that would have otherwise been used to transmit transmissions or RVs that cannot be decoded by the UE 120).

Additionally, or alternatively, the UE 120 may transmit the forced ACK communication based on a number of transmitted NACK indications and/or a number of received retransmissions for the HARQ process satisfying a termination threshold. The termination threshold may be based on the HARQ information. For example, as described elsewhere herein, the HARQ information may indicate a number of NACK communications between an initial retransmission of TBs with the reserved MCS and the retransmission of the indication of the MCS. In other words, the HARQ information may indicate a number of NACK communications that cause (or trigger) the network node 110 to retransmit the decoding information during a given HARQ process. The termination threshold may be based on the number of NACK communications. For example, the termination threshold may be (e.g., may be equal to) the number of NACK communications. The UE 120 may determine that the number of transmitted NACK indications and/or a number of received retransmissions for the HARQ process satisfies the termination threshold. Therefore, the UE 120 may transmit the forced ACK communication for the HARQ process (e.g., to cause the HARQ process and/or retransmissions for the HARQ process to be terminated or discarded).

As shown by reference number 585, the network node 110 may terminate the retransmissions associated with the remaining RVs of MAC TB based on the reception of the forced ACK communication. As shown by reference number 590, the network node 110 may transmit, and the UE 120 may receive, a different RV that is associated with a next MAC TB. As a result, a latency associated with transitioning to a HARQ process with the next MAC TB may be reduced (e.g., because the network node 110 does not transmit all transmissions or RVs for the HARQ process before moving on to the transmission of the next MAC TB). The UE 120 may be enabled to recover the MAC TB (e.g., associated with the terminated HARQ process) via one or more RLC operations (e.g., an RLC retransmission). Additionally, this may improve the throughput for the downlink channel by reducing a likelihood that the downlink channel is used for transmissions that cannot be successfully decoded by the UE 120.

As indicated above, FIGS. 5A and 5B are provided as examples. Other examples may differ from what is described with respect to FIGS. 5A and 5B.

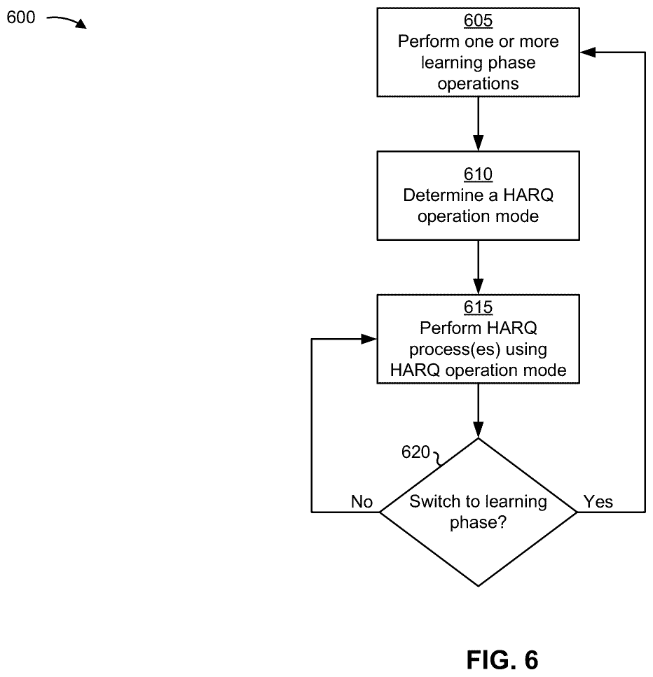

FIG. 6 is a diagram of an example process 600 associated with adaptation of a HARQ operation mode, in accordance with the present disclosure. The process 600 may be performed by a receiver (e.g., a receiver of a communication associated with one or more HARQ processes), such as the UE 120 or the network node 110.

As shown in FIG. 6, the process 600 may include performing one or more learning phase operations (block 605). For example, the receiver may perform the one or more learning phase operations. The one or more learning phase operations may include obtaining HARQ information associated with a transmitter (e.g., a transmitter of the communication associated with one or more HARQ processes, such as the network node 110 or the UE 120), in a similar manner as described elsewhere herein. For example, the one or more learning phase operations may include operations as described in connection with FIG. 5A, reference number 515, reference number 520, reference number 525, and/or reference number 530, among other examples.

The receiver performing the one or more learning phase operations may be referred to as the receiver operating in a “learning” mode. For example, as described elsewhere herein, the receiver may perform the one or more learning phase operations to obtain the HARQ information. The receiver may determine one or more operations supported by the transmitter and/or a scheduling pattern for HARQ processes associated with the transmitter based on the HARQ information. For example, the receiver may determine whether the transmitter is configured to perform a retransmission of full decoding information during a given HARQ process, as described in more detail elsewhere herein.

The process 600 may include determining a HARQ operation mode (block 610). For example, the receiver may determine the HARQ operation mode. The receiver may determine the HARQ operation mode based on the HARQ information. The HARQ operation mode may include a forced ACK mode, an adapted forced ACK mode, and/or a normal HARQ mode. The forced ACK mode may include the receiver transmitting a forced ACK communication based on, or in response to, determining that decoding information for the HARQ process is lost (e.g., based on determining that an the decoding information was not detected and/or was not successfully received by the receiver). For example, the forced ACK mode may include the receiver transmitting the forced ACK in response to receiving an RV or retransmission (such as an RV 2) that includes a reserved MCS (e.g., prior to the receiver obtaining the decoding information for the HARQ process).

The adapted forced ACK mode may be associated with an adapted timing of forced ACK transmissions by the receiver. For example, the HARQ information (e.g., obtained during the learning phase) may indicate that the transmitter is configured to transmit a retransmission of decoding information after a given number of NACK indications during a given HARQ process. The adapted forced ACK mode may be associated with the receiver transmitting a forced ACK communication only after the given number of NACK indications have been transmitted during a given HARQ process. The normal HARQ mode may be associated with the receiver performing HARQ operations as defined, or otherwise fixed, by a wireless communication standard, such as the 3GPP. For example, the normal HARQ mode may be associated with the receiver disabling (or refraining from performing) forced ACK communications.

The receiver may determine the HARQ operation mode based on the HARQ information. For example, the receiver may determine the HARQ operation mode based on whether the transmitter is configured to perform a retransmission of an indication of decoding information prior to an end of a given HARQ process. If the HARQ information indicates that the transmitter is not configured to perform a retransmission of an indication of decoding information prior to an end of a given HARQ process, then the receiver may determine that the HARQ operation mode is the forced ACK mode. If the HARQ information indicates that the transmitter is configured to perform a retransmission of an indication of decoding information prior to an end of a given HARQ process, then the receiver may determine that the HARQ operation mode is the adapted forced ACK mode or the normal HARQ mode.

In some aspects, a HARQ feedback mode may be associated with a “third” HARQ feedback state (e.g., in addition to an ACK HARQ feedback state and a NACK HARQ feedback state). The third HARQ feedback state may be associated with lost decoding information. For example, the receiver may be configured to transmit a HARQ feedback communication indicating that full decoding information is unavailable at the receiver based on the reception of a retransmission of a TB that uses a reserved MCS when full decoding information for the TB is unavailable at the receiver (e.g., has not yet been received by the receiver). The transmitter may be configured to transmit a retransmission of the full decoding information in response to receiving HARQ feedback associated with the third HARQ feedback state. For example, the transmitter may transmit, and the receiver may receive, a retransmission of the full decoding information for a TB based on the communication of the HARQ feedback communication indicating that full decoding information is unavailable at the receiver. As described elsewhere herein, this may be referred to as “restarting” the HARQ process for the TB. The receiver may use the full decoding information and any received retransmissions (e.g., RVs) of the TB to decode the TB (e.g., where the retransmissions may be received before and/or after the reception of the full decoding information).

In some aspects, the receiver may determine the HARQ operation mode based on one or more communication parameters, such as an MCS, a downlink throughput, and/or another communication parameter. For example, if downlink communications from the transmitter are associated with a high MCS (e.g., an MCS index that satisfies a threshold), then the receiver may determine that the HARQ operation mode is the forced ACK mode (e.g., even if the HARQ information indicates that the transmitter is configured to perform a retransmission of an indication of decoding information) because the receiver may be unable to decode a TB with a limited number of (remaining) retransmissions at the high MCS. As another example, if the downlink throughput satisfies a throughput threshold, then the receiver may determine that the HARQ operation mode is the forced ACK mode or the adapted forced ACK mode (e.g., to facilitate a high throughput being maintained). If the downlink throughput does not satisfy a throughput threshold, then the receiver may determine that the HARQ operation mode is the normal HARQ mode or the adapted forced ACK mode (e.g. to facilitate the lowest possible error rate and/or highest reliability).

Determining the HARQ operation mode may enable the receiver to tailor the HARQ mode to the operation(s) of the transmitter. For example, where the transmitter is configured to perform a retransmission of an indication of decoding information prior to an end of a given HARQ process, the receiver may use the adapted forced ACK mode (e.g., to transmit a forced ACK communication only after the given number of NACK indications have been transmitted during a given HARQ process). This may improve a likelihood that a TB is able to be decoded during a given HARQ process, thereby reducing a likelihood of one or more RLC retransmissions and reducing a latency associated with the receiver obtaining the TB. In addition, when ordered delivery is configured, all the traffic subsequent to the TB is also delayed, requiring buffering in the receiver. Avoiding an RLC retransmission may reduce a likelihood of the buffering of the subsequent traffic, thereby conserving processing resources and/or memory resources of the receiver. Where the transmitter is not configured to perform a retransmission of an indication of decoding information prior to an end of a given HARQ process, the receiver may use the forced ACK mode to conserve time and/or resources (e.g., network resources or processing resources) that would have otherwise been used for the transmission of one or more RVs that the receiver is unable to decode.

The process 600 may include performing one or more HARQ processes using the determined HARQ operation mode (block 615). For example, the receiver may perform one or more HARQ processes using the determined HARQ operation mode. The receiver performing the one or more HARQ processes using the determined HARQ operation mode may be referred to as the receiver operating in an “adapt” mode or an “adaptation” mode.

The process 600 may include determining whether to switch to the learning phase (block 620). For example, the receiver may determine whether to switch to the learning phase. For example, the receiver may determine whether to switch from operating in the adapt mode to operating in the learning mode. If the receiver determines to switch to the learning phase (block 620—Yes), then the receiver may return to performing the one or more learning phase operations (block 605). If the receiver determines to not switch to the learning phase (block 620—No), then the receiver may continue to perform the HARQ process(es) in the determined HARQ operation mode (block 615).

In some aspects, the receiver may periodically switch to the learning phase. For example, the receiver may operate in the learning mode in accordance with a periodic schedule (e.g., may obtain the HARQ information in accordance with a periodic schedule). Additionally, or alternatively, the receive may switch to the learning phase based on detecting an event. For example, the receiver may detect an event that triggers the receiver to switch to the learning phase (e.g., that triggers the obtaining of the HARQ information). For example, the receiver may switch between operating in the learning mode and the adapt mode based on transmitter behavior (e.g., based on network behavior) which may change over time.

For example, the event may include reception of a cell configuration and/or detecting that the cell configuration has changed. For example, the receiver may switch between operating in the learning mode and the adapt mode based on cell information, such as coverage information, capacity information, terrestrial information (e.g., whether the network is a terrestrial network or a non-terrestrial network (NTN)), numerology information (e.g., an SCS), an operating band (e.g., sub-6 GHz band or a millimeter wave band), among other examples.

As another example, the event may include detecting a failure to receive the retransmission of the decoding information (e.g., an indication of the MCS) when expected. For example, as described above, the HARQ information may indicate that the transmitter is configured to transmit the retransmission of the decoding information after a given number of NACK indications. If the receiver detects that a retransmission of the decoding information is not received after the given number of NACK indications for one or more HARQ processes, then the receiver may determine to switch to the learning phase.

As another example, the event may include a reception of an RRC configuration or reconfiguration. For example, the receiver may switch between the learning mode and the adapt mode based on receiving an RB configuration (or another RRC) configuration, such as after performing N HARQ operations in the learning phase. As another example, the event may include a number of HARQ processes performed (e.g., in the determine HARQ operation mode) satisfying a threshold. As another example, the event may include a reception of an RLC configuration or a radio bearer configuration. For example, the receiver may switch between the learning mode and the adapt mode based on an RLC mode (e.g., an RLC acknowledged mode (AM) or an RLC UM). As another example, the event may include a reception of a quality of service (QoS) configuration. For example, the receiver may switch between the learning mode and the adapt mode based on QoS requirements of a flow associated with one or more HARQ processes. For example, if a QoS parameter for a given flow changes, then the receiver may switch to the learning phase to obtain the HARQ information for the changed QoS parameter.

As another example, the event may include a switch of a PDU session type. For example, the receiver may switch between the learning mode and the adapt mode based on a PDU session type and/or network slice information, among other examples. As another example, the event may include detecting or receiving a handover command. For example, the receiver may switch to the learning phase based on receiving a handover command (or performing a handover) to obtain HARQ information for a new transmitter (e.g., to which the receiver was handed over).

For example, the switch between the learning mode and the adapt mode and/or one or more parameters of the adapted forced ACK mode (such as a threshold associated with transmitting forced ACK communications) may be based on a type of radio bearer configuration (e.g., AM or UM), a type of QoS requirement(s), a PDU session type, and/or network slicing information, among other examples. Additionally, or alternatively, the switch between the learning mode and the adapt mode and/or one or more parameters of the adapted forced ACK mode may be based on an output of a machine learning model. For example, the receiver may deploy the machine learning model. An input to the machine learning model may include the HARQ information. The output of the machine learning model may include whether to switch between the learning mode and the adapt mode, one or more parameters of the forced ACK mode, and/or an indication of which HARQ operation mode should be used by the receiver, among other examples. For example, the switch between the learning mode and the adapt mode and/or one or more parameters of the adapted forced ACK mode may be based on filtered historical HARQ information (e.g., using a machine learning model to filter the historical HARQ information).

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with techniques for adaptation of HARQ retransmission handling.

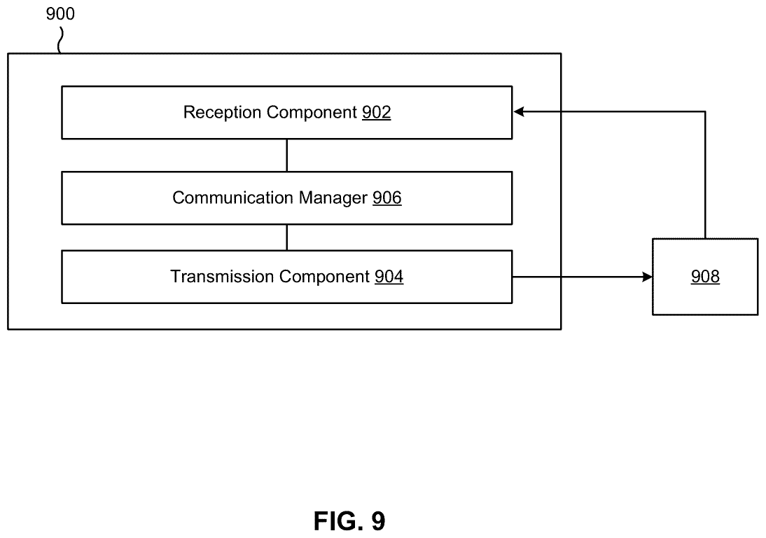

As shown in FIG. 7, in some aspects, process 700 may include obtaining HARQ information associated with a network node, wherein the HARQ information indicates whether the network node is configured to perform a retransmission of an indication of an MCS prior to an end of HARQ processes associated with the network node (block 710). For example, the UE (e.g., using reception component 902 and/or communication manager 906, depicted in FIG. 9) may obtain HARQ information associated with a network node, wherein the HARQ information indicates whether the network node is configured to perform a retransmission of an indication of an MCS prior to an end of HARQ processes associated with the network node, as described above.

In some aspects, process 700 may include detecting, for a HARQ process associated with a downlink communication from the network node, that a transmission of an RV of a TB of the downlink communication is unsuccessful. For example, the UE (e.g., using communication manager 906, depicted in FIG. 9) may detect, for a HARQ process associated with a downlink communication from the network node, that a transmission of an RV of a TB of the downlink communication is unsuccessful, as described above.

As further shown in FIG. 7, in some aspects, process 700 may include receiving, for a HARQ process associated with a downlink communication from the network node, a retransmission of a TB of the downlink communication, wherein the retransmission is associated with a reserved MCS and full decoding information for the TB is unavailable (block 720). For example, the UE (e.g., using reception component 902 and/or communication manager 906, depicted in FIG. 9) may receive, for a HARQ process associated with a downlink communication from the network node, a retransmission of a TB of the downlink communication, wherein the retransmission is associated with a reserved MCS and full decoding information for the TB is unavailable, as described above.

As further shown in FIG. 7, in some aspects, process 700 may include performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process (block 730). For example, the UE (e.g., using communication manager 906, depicted in FIG. 9) may perform, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process, as described above.

Process 700 may include additional aspects, such as any single aspect or any combination of aspects described below and/or in connection with one or more other processes described elsewhere herein.

In a first aspect, process 700 includes transmitting, for the HARQ process and to the network node, one or more NACK communications in response to the retransmission and any subsequent retransmissions of the TB associated with respective RVs, and performing the action includes transmitting, based on the network node is configured to perform the retransmission of the indication of the MCS prior to the end of each HARQ process, a HARQ ACK communication to terminate the HARQ process based on a number of the one or more NACK communications satisfying a threshold, wherein the threshold is based on the HARQ information.

In a second aspect, alone or in combination with the first aspect, obtaining the HARQ information includes identifying the threshold based on a number of NACK communications between an initial retransmission of TBs with the reserved MCS and the retransmission of the indication of the MCS.

In a third aspect, alone or in combination with one or more of the first and second aspects, the threshold is the number of NACK communications.

In a fourth aspect, alone or in combination with one or more of the first through third aspects, performing the action includes transmitting, in response to the reception of the retransmission and based on the network node not being configured to perform the retransmission of the indication of the MCS prior to the end of each HARQ process, a HARQ ACK communication (e.g., a forced ACK communication) to terminate the HARQ process.

In a fifth aspect, alone or in combination with one or more of the first through fourth aspects, the HARQ information indicates that an index of the MCS satisfies an MCS threshold, and performing the action includes transmitting, in response to the reception of the retransmission and based on the index of the MCS satisfying the MCS threshold, a HARQ ACK communication (e.g., a forced ACK communication) to terminate the HARQ process.

In a sixth aspect, alone or in combination with one or more of the first through fifth aspects, obtaining the HARQ information includes obtaining the HARQ information in accordance with a periodic schedule.

In a seventh aspect, alone or in combination with one or more of the first through sixth aspects, process 700 includes detecting an event that triggers the obtaining of the HARQ information.

In an eighth aspect, alone or in combination with one or more of the first through seventh aspects, the event includes at least one of reception of a cell configuration, a switch of an SCS, a failure to receive the retransmission of the indication of the MCS, reception of an RRC configuration, a number of HARQ processes performed satisfying a threshold, a reception of an RLC configuration, reception of a radio bearer configuration, a reception of a QoS configuration, or a switch of a PDU session type.

In a ninth aspect, alone or in combination with one or more of the first through eighth aspects, performing the action includes storing, based on the network node being configured to perform the retransmission of the indication of the MCS prior to the end of each HARQ process, samples associated with the retransmission of the TB, wherein the samples are associated with a full bandwidth size, transmitting, for the HARQ process and to the network node, one or more NACK communications in response to the retransmission and any subsequent retransmissions of the TB associated with respective RVs, receiving, from the network node, another RV of the TB that includes the retransmission of the indication of the MCS, and obtaining, based on the MCS, the other RV, and the retransmission of the TB, the TB.

In a tenth aspect, alone or in combination with one or more of the first through ninth aspects, the HARQ information indicates a downlink throughput, and the action is based on whether the downlink throughput satisfies a throughput threshold.

In an eleventh aspect, alone or in combination with one or more of the first through tenth aspects, the downlink throughput does not satisfy the throughput threshold, and the performance of the action causes the UE to proceed with the HARQ process.

In a twelfth aspect, alone or in combination with one or more of the first through eleventh aspects, the downlink throughput satisfies the throughput threshold, and the performance of the action causes the UE to terminate the HARQ process.

In a thirteenth aspect, alone or in combination with one or more of the first through twelfth aspects, performing the action includes transmitting, to the network node, a HARQ feedback communication indicating that the full decoding information for the TB is unavailable to restart the HARQ process.

In a fourteenth aspect, alone or in combination with one or more of the first through thirteenth aspects, the process 700 includes receiving, from the network node and for the HARQ process, an indication of the full decoding information based on the transmission of the HARQ feedback communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

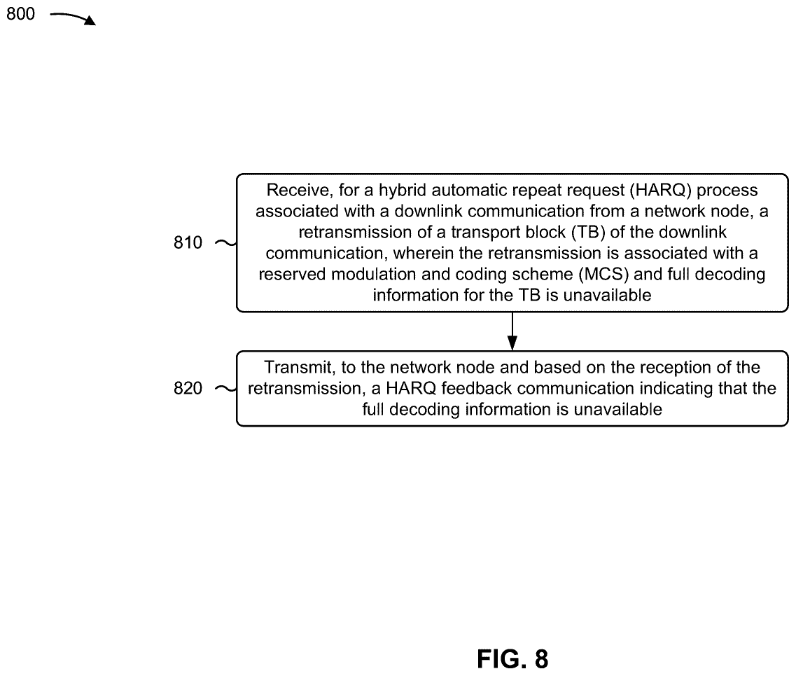

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with techniques for adaptation of hybrid automatic repeat request retransmission handling.

As shown in FIG. 8, in some aspects, process 800 may include receiving, for a HARQ process associated with a downlink communication from a network node, a retransmission of a TB of the downlink communication, wherein the retransmission is associated with a reserved MCS and full decoding information for the TB is unavailable (block 810). For example, the UE (e.g., using reception component 902 and/or communication manager 906, depicted in FIG. 9) may receive, for a HARQ process associated with a downlink communication from a network node, a retransmission of a TB of the downlink communication, wherein the retransmission is associated with a reserved MCS and full decoding information for the TB is unavailable, as described above.

As further shown in FIG. 8, in some aspects, process 800 may include transmitting, to the network node and based on the reception of the retransmission, a HARQ feedback communication indicating that the full decoding information is unavailable (block 820). For example, the UE (e.g., using transmission component 904 and/or communication manager 906, depicted in FIG. 9) may transmit, to the network node and based on the reception of the retransmission, a HARQ feedback communication indicating that the full decoding information is unavailable, as described above.

Process 800 may include additional aspects, such as any single aspect or any combination of aspects described below and/or in connection with one or more other processes described elsewhere herein.

In a first aspect, process 800 includes receiving, based on the transmission of the HARQ feedback communication, an indication of the full decoding information.

In a second aspect, alone or in combination with the first aspect, the HARQ feedback communication is associated with a HARQ state for lost decoding information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A, 5B, and/or 6. Additionally, or alternatively, the apparatus 900 may be configured to perform one or more processes described herein, such as process 700 of FIG. 7 and/or process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may obtain HARQ information, wherein the HARQ information indicates whether the network node is configured to perform a retransmission of decoding information (e.g., an indication of an MCS) prior to an end of HARQ processes associated with the network node. The communication manager 906 may detect, for a HARQ process associated with a downlink communication from the network node, that a transmission of an RV of a TB of the downlink communication is unsuccessful. The reception component 902 may receive, from the network node, a retransmission of the TB, wherein the retransmission is associated with a reserved MCS. The communication manager 906 may perform, based on the reception of the retransmission of the TB, an action to proceed with the HARQ process or to terminate the HARQ process, wherein the action is based on whether the network node is configured to perform the retransmission of decoding information prior to the end of each HARQ process.

The transmission component 904 may transmit, for the HARQ process and to the network node, one or more NACK communications in response to the retransmission and any subsequent retransmissions of the TB associated with respective RVs.

The communication manager 906 may detect an event that triggers the obtaining of the HARQ information.

The reception component 902 may receive, for a HARQ process associated with a downlink communication, a retransmission of a TB of the downlink communication, wherein the retransmission is associated with a reserved MCS and full decoding information for the TB is unavailable. The transmission component 904 may transmit, based on the reception of the retransmission, a HARQ feedback communication indicating that the full decoding information is unavailable. The reception component 902 may receive, based on the transmission of the HARQ feedback communication, an indication of the full decoding information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: obtaining hybrid automatic repeat request (HARQ) information associated with a network node, wherein the HARQ information indicates whether the network node is configured to perform a retransmission of an indication of a modulation and coding scheme (MCS) prior to an end of HARQ processes associated with the network node; receiving, for a HARQ process associated with a downlink communication from the network node, a retransmission of a TB of the downlink communication, wherein the retransmission is associated with a reserved MCS and full decoding information for the TB is unavailable; and performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

Aspect 2: The method of Aspect 1, further comprising: transmitting, for the HARQ process and to the network node, one or more negative acknowledgement (NACK) communications in response to the retransmission and any subsequent retransmissions of the TB associated with respective RVs; and wherein performing the action comprises: transmitting, based on the network node is configured to perform the retransmission of the indication of the MCS prior to the end of each HARQ process, a HARQ acknowledgement (ACK) communication to terminate the HARQ process based on a number of the one or more NACK communications satisfying a threshold, wherein the threshold is based on the HARQ information, wherein performing the action comprises: transmitting, based on the network node is configured to perform the retransmission of the indication of the MCS prior to the end of each HARQ process, a HARQ acknowledgement (ACK) communication to terminate the HARQ process based on a number of the one or more NACK communications satisfying a threshold, wherein the threshold is based on the HARQ information.

Aspect 3: The method of Aspect 2, wherein obtaining the HARQ information comprises: identifying the threshold based on a number of NACK communications between an initial retransmission of TBs with the reserved MCS and the retransmission of the indication of the MCS.

Aspect 4: The method of Aspect 3, wherein the threshold is the number of NACK communications.

Aspect 5: The method of any of Aspects 1-4, wherein performing the action comprises: transmitting, in response to the reception of the retransmission and based on the network node not being configured to perform the retransmission of the indication of the MCS prior to the end of each HARQ process, a HARQ acknowledgement (ACK) communication to terminate the HARQ process.

Aspect 6: The method of any of Aspects 1-5, wherein the HARQ information indicates that an index of the MCS satisfies an MCS threshold, and wherein performing the action comprises: transmitting, in response to the reception of the retransmission and based on the index of the MCS satisfying the MCS threshold, a HARQ acknowledgement (ACK) communication to terminate the HARQ process.

Aspect 7: The method of any of Aspects 1-6, wherein obtaining the HARQ information comprises: obtaining the HARQ information in accordance with a periodic schedule.

Aspect 8: The method of any of Aspects 1-7, further comprising: detecting an event that triggers the obtaining of the HARQ information.

Aspect 9: The method of Aspect 8, wherein the event includes at least one of: reception of a cell configuration, a switch of a subcarrier spacing (SCS), a failure to receive the retransmission of the indication of the MCS, reception of a radio resource control (RRC) configuration, a number of HARQ processes performed satisfying a threshold, reception a radio link control (RLC) configuration, reception of a radio bearer configuration, reception of a quality of service (QOS) configuration, or a switch of a protocol data unit (PDU) session type.

Aspect 10: The method of any of Aspects 1-9, wherein performing the action comprises: storing, based on the network node being configured to perform the retransmission of the indication of the MCS prior to the end of each HARQ process, samples associated with the retransmission of the TB, wherein the samples are associated with a full bandwidth size; transmitting, for the HARQ process and to the network node, one or more negative acknowledgement (NACK) communications in response to the retransmission and any subsequent retransmissions of the TB associated with respective RVs; receiving, from the network node, another RV of the TB that includes the retransmission of the indication of the MCS; and obtaining, based on the MCS, the other RV, and the retransmission of the TB, the TB.

Aspect 11: The method of any of Aspects 1-10, wherein the HARQ information indicates a downlink throughput, and wherein the action is based on whether the downlink throughput satisfies a throughput threshold.

Aspect 12: The method of Aspect 11, wherein the downlink throughput does not satisfy the throughput threshold, and wherein the performance of the action causes the UE to proceed with the HARQ process.

Aspect 13: The method of any of Aspects 11-12, wherein the downlink throughput satisfies the throughput threshold, and wherein the performance of the action causes the UE to terminate the HARQ process.

Aspect 14: The method of any of Aspects 1-13, wherein performing the action comprises: transmitting, to the network node, a HARQ feedback communication indicating that the full decoding information for the TB is unavailable to restart the HARQ process.

Aspect 15: The method of Aspect 14, further comprising: receiving, from the network node and for the HARQ process, an indication of the full decoding information based on the transmission of the HARQ feedback communication.

Aspect 16: A method of wireless communication performed by a user equipment (UE), comprising: receiving, for a hybrid automatic repeat request (HARQ) process associated with a downlink communication from a network node, a retransmission of a transport block (TB) of the downlink communication, wherein the retransmission is associated with a reserved modulation and coding scheme (MCS) and full decoding information for the TB is unavailable; and transmitting, to the network node and based on the reception of the retransmission, a HARQ feedback communication indicating that the full decoding information is unavailable.

Aspect 17: The method of Aspect 16, further comprising: receiving, based on the transmission of the HARQ feedback communication, an indication of the full decoding information.

Aspect 18: The method of any of Aspects 16-17, wherein the HARQ feedback communication is associated with a HARQ state for lost decoding information.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
obtaining hybrid automatic repeat request (HARQ) information associated with a network node, wherein the HARQ information indicates whether the network node is configured to perform a retransmission of an indication of a modulation and coding scheme (MCS) prior to an end of HARQ processes associated with the network node;
receiving, for a HARQ process associated with a downlink communication from the network node, a retransmission of a transport block (TB) of the downlink communication, wherein the retransmission is associated with a reserved MCS, and wherein full decoding information for the TB is unavailable; and
performing, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

2. The method of claim 1, further comprising:
transmitting, for the HARQ process and to the network node, one or more negative acknowledgement (NACK) communications in response to the retransmission and any subsequent retransmissions of the TB; and
wherein performing the action comprises:
transmitting, based on the network node is configured to perform the retransmission of the indication of the MCS prior to the end of each HARQ process, a HARQ acknowledgement (ACK) communication to terminate the HARQ process based on a number of the one or more NACK communications satisfying a threshold, wherein the threshold is based on the HARQ information.

3. The method of claim 2, wherein obtaining the HARQ information comprises:
identifying the threshold based on a number of NACK communications between an initial retransmission of TBs with the reserved MCS and the retransmission of the indication of the MCS.

4. The method of claim 1, wherein performing the action comprises:
transmitting, in response to the reception of the retransmission and based on the network node not being configured to perform the retransmission of the indication of the MCS prior to the end of each HARQ process, a HARQ acknowledgement (ACK) communication to terminate the HARQ process.

5. The method of claim 1, wherein the HARQ information indicates that an index of the MCS satisfies an MCS threshold, and wherein performing the action comprises:
transmitting, in response to the reception of the retransmission and based on the index of the MCS satisfying the MCS threshold, a HARQ acknowledgement (ACK) communication to terminate the HARQ process.

6. The method of claim 1, wherein obtaining the HARQ information comprises:
obtaining the HARQ information in accordance with a periodic schedule.

7. The method of claim 1, further comprising:
detecting an event that triggers the obtaining of the HARQ information.

8. The method of claim 1, wherein performing the action comprises:
storing, based on the network node being configured to perform the retransmission of the indication of the MCS prior to the end of each HARQ process, samples associated with the retransmission of the TB, wherein the samples are associated with a full bandwidth size;
transmitting, for the HARQ process and to the network node, one or more negative acknowledgement (NACK) communications in response to the retransmission and any subsequent retransmissions of the TB associated with respective RVs;
receiving, from the network node, another RV of the TB that includes the retransmission of the indication of the MCS; and
obtaining, based on the MCS, the other RV, and the retransmission of the TB, the TB.

9. The method of claim 1, wherein the HARQ information indicates a downlink throughput, and wherein the action is based on whether the downlink throughput satisfies a throughput threshold.

10. The method of claim 9, wherein the downlink throughput does not satisfy the throughput threshold, and wherein the performance of the action causes the UE to proceed with the HARQ process.

11. The method of claim 9, wherein the downlink throughput satisfies the throughput threshold, and wherein the performance of the action causes the UE to terminate the HARQ process.

12. The method of claim 1, wherein performing the action comprises:
transmitting, to the network node, a HARQ feedback communication indicating that the full decoding information for the TB is unavailable to restart the HARQ process.

13. The method of claim 12, further comprising:
receiving, from the network node and for the HARQ process, an indication of the full decoding information based on the transmission of the HARQ feedback communication.

14. An apparatus for wireless communication at a user equipment (UE), comprising:
one or more memories; and
one or more processors, coupled to the one or more memories, individually or collectively configured to cause the UE to:
obtain hybrid automatic repeat request (HARQ) information associated with a network node, wherein the HARQ information indicates whether the network node is configured to perform a retransmission of an indication of a modulation and coding scheme (MCS) prior to an end of HARQ processes associated with the network node;
receive, for a HARQ process associated with a downlink communication from the network node, a retransmission of a transport block (TB) of the downlink communication, wherein the retransmission is associated with a reserved MCS, and wherein full decoding information for the TB is unavailable; and
perform, based on the reception of the retransmission of the TB, an action to proceed with the HARQ process, to restart the HARQ process, or to terminate the HARQ process, wherein the action is based on whether the network node is configured to perform the retransmission of the indication of the MCS prior to the end of each HARQ process.

15. The apparatus of claim 14, wherein the one or more processors are further configured to cause the UE to:
transmit, for the HARQ process and to the network node, one or more negative acknowledgement (NACK) communications in response to the retransmission and any subsequent retransmissions of the TB associated with respective RVs; and
wherein the one or more processors, to cause the UE to perform the action, are configured to cause the UE to:
transmit, based on the network node is configured to perform the retransmission of the indication of the MCS prior to the end of each HARQ process, a HARQ acknowledgement (ACK) communication to terminate the HARQ process based on a number of the one or more NACK communications satisfying a threshold, wherein the threshold is based on the HARQ information.

16. The apparatus of claim 15, wherein the one or more processors, to cause the UE to obtain the HARQ information, are configured to cause the UE to:
identify the threshold based on a number of NACK communications between an initial retransmission of TBs with the reserved MCS and the retransmission of the indication of the MCS.

17. The apparatus of claim 16, wherein the threshold is the number of NACK communications.

18. The apparatus of claim 14, wherein the one or more processors, to cause the UE to perform the action, are configured to cause the UE to:
transmit, in response to the reception of the retransmission and based on the network node not being configured to perform the retransmission of the indication of the MCS prior to the end of each HARQ process, a HARQ acknowledgement (ACK) communication to terminate the HARQ process.

19. The apparatus of claim 14, wherein the HARQ information indicates that an index of the MCS satisfies an MCS threshold, and wherein the one or more processors, to cause the UE to perform the action, are configured to cause the UE to:
transmit, in response to the reception of the retransmission and based on the index of the MCS satisfying the MCS threshold, a HARQ acknowledgement (ACK) communication to terminate the HARQ process.

20. The apparatus of claim 14, wherein the one or more processors are further configured to cause the UE to:
detect an event that triggers the obtaining of the HARQ information.

21. The apparatus of claim 20, wherein the event includes at least one of:
reception of a cell configuration,
a switch of a subcarrier spacing (SCS),
a failure to receive the retransmission of the indication of the MCS,
reception of a radio resource control (RRC) configuration,
a number of HARQ processes performed satisfying a threshold,
reception a radio link control (RLC) configuration,
reception of a radio bearer configuration,
reception of a quality of service (QOS) configuration, or
a switch of a protocol data unit (PDU) session type.

22. The apparatus of claim 14, wherein the one or more processors, to cause the UE to perform the action, are configured to cause the UE to:
store, based on the network node being configured to perform the retransmission of the indication of the MCS prior to the end of each HARQ process, samples associated with the retransmission of the TB, wherein the samples are associated with a full bandwidth size;
transmit, for the HARQ process and to the network node, one or more negative acknowledgement (NACK) communications in response to the retransmission and any subsequent retransmissions of the TB associated with respective RVs;
receive, from the network node, another RV of the TB that includes the retransmission of the indication of the MCS; and
obtain, based on the MCS, the other RV, and the retransmission of the TB, the TB.

23. The apparatus of claim 14, wherein the HARQ information indicates a downlink throughput, and wherein the action is based on whether the downlink throughput satisfies a throughput threshold.

24. The apparatus of claim 14, wherein the one or more processors, to cause the UE to perform the action, are configured to cause the UE to:
transmit, to the network node, a HARQ feedback communication indicating that the full decoding information for the TB is unavailable to restart the HARQ process.

25. The apparatus of claim 24, wherein the one or more processors are further configured to cause the UE to:
receive, from the network node and for the HARQ process, an indication of the full decoding information based on the transmission of the HARQ feedback communication.

26. An apparatus for wireless communication at a user equipment (UE), comprising:
one or more memories; and
one or more processors, coupled to the one or more memories, individually or collectively configured to cause the UE to:
receive, for a hybrid automatic repeat request (HARQ) process associated with a downlink communication from a network node, a retransmission of a transport block (TB) of the downlink communication, wherein the retransmission is associated with a reserved modulation and coding scheme (MCS) and full decoding information for the TB is unavailable; and
transmit, to the network node and based on the reception of the retransmission, a HARQ feedback communication indicating that the full decoding information is unavailable.

27. The apparatus of claim 26, wherein the one or more processors are further configured to cause the UE to:
receive, based on the transmission of the HARQ feedback communication, an indication of the full decoding information.

28. The apparatus of claim 26, wherein the HARQ feedback communication is associated with a HARQ state for lost decoding information.

29. A method of wireless communication performed by a user equipment (UE), comprising:
receiving, for a hybrid automatic repeat request (HARQ) process associated with a downlink communication from a network node, a retransmission of a transport block (TB) of the downlink communication, wherein the retransmission is associated with a reserved modulation and coding scheme (MCS) and full decoding information for the TB is unavailable; and
transmitting, to the network node and based on the reception of the retransmission, a HARQ feedback communication indicating that the full decoding information is unavailable.

30. The method of claim 29, further comprising:
receiving, based on the transmission of the HARQ feedback communication, an indication of the full decoding information.
